(19) United States
(12) Patent Application Publication
(10) Pub. No.: US 2017/0189908 A1
(43) Pub. Date: Jul. 6, 2017

(54) DROPLET ASSAY SYSTEM WITH AUTOMATIC CALIBRATION

(71) Applicant: Bio-Rad Laboratories, Inc., Hercules, CA (US)

(72) Inventors: John Dzenitis, Danville, CA (US); Stefano Schiaffino, Pleasanton, CA (US)

(21) Appl. No.: 15/395,199

(22) Filed: Dec. 30, 2016

Related U.S. Application Data
(60) Provisional application No. 62/273,359, filed on Dec. 30, 2015.

(51) Int. Cl. B01L 3/00

(52) U.S. Cl. CPC B01L 3/502784; B01L 2200/148; B01L 2300/021; B01L 2300/0663; B01L 2200/12

(57) ABSTRACT

The present disclosure provides systems and methods for performing droplet assays with automatic calibration. An exemplary assay system may comprise a cartridge including a plurality of droplet generators to form emulsions of droplets having a same nominal volume. A tag may be associated with the cartridge and may encode calibration data or an identifier thereof. The calibration data may include a respective value specific to each droplet generator. The system further may include a detection system to detect a signal representing an analyte from droplets of each emulsion, and a reader to read the calibration data or the identifier from the tag. The system still further may include a processor configured to receive the signal and the calibration data and to calculate, for each emulsion, a concentration of an analyte using at least the signal and the respective value specific to the droplet generator that formed the emulsion.

### CROSS-REFERENCE TO PRIORITY APPLICATION

This application is based upon and claims the benefit under 35 U.S.C. §119(e) of U.S. Provisional Patent Application Ser. No. 62/273,359, filed Dec. 30, 2015, which is incorporated herein by reference in its entirety for all purposes.

### CROSS-REFERENCES TO OTHER MATERIALS

This application incorporates by reference in their entirety for all purposes the following materials: U.S. patent application Ser. No. 15/394,624, filed Dec. 29, 2016; U.S. Patent Application Publication No. 2010/0173394 A1, published Jul. 8, 2010; U.S. Patent Application Publication No. 2012/0152369 A1, published Jun. 21, 2012; U.S. Patent Application Publication No. 2012/0190033 A1, published Jul. 26, 2012; U.S. Patent Application Publication No. 2014/0312534 A1, published Oct. 23, 2014; U.S. Patent Application Publication No. 2014/0378348 A1, published Dec. 25, 2014; and Joseph R. Lakowicz, PRINCIPLES OF FLUORESCENCE SPECTROSCOPY (2^{nd} Ed. 1999).

### INTRODUCTION

Assays performed with emulsions can quantify an analyte present in a small fluid sample. For example, digital PCR in droplets enables accurate measurement of the concentration of nucleic acid target sequences from microliter-scale or smaller samples. The concentration may be reported as a molar number of target molecules per unit volume of the sample. Calculation of the concentration thus relies in part on knowledge of the average volume of droplets in the assay. However, the average volume can depend on a complex set of parameters, such as microfluidic channel sizes of the droplet generator used, flow rates of emulsion phases (e.g., aqueous and oil phases) during droplet generation, fluidic properties of the emulsion phases, wetting behavior of the emulsion phases on walls of the droplet generator, and many other factors. Accordingly, droplet volume errors can occur when any of the parameters change, making accurate concentration measurements challenging, particularly with smaller droplets. Amongst many factors, these parameters can change as a result of manufacturing variations in droplet-generation devices and instruments, in the physical and chemical formulations of aqueous and oil phases, and from environmental changes during operation. Approaches are needed to improve the accuracy and precision of droplet assays.

### SUMMARY

The present disclosure provides systems and methods for performing droplet assays with automatic calibration. An exemplary assay system may comprise a cartridge including a plurality of droplet generators to form emulsions of droplets having a same nominal volume. A tag may be associated with the cartridge and may encode calibration data or an identifier thereof. The calibration data may include a respective value specific to each droplet generator. The system further may include a detection system to detect a signal representing an analyte from droplets of each emulsion, and a reader to read the calibration data or the identifier from the tag. The system still further may include a processor configured to receive the signal and the calibration data and to calculate, for each emulsion, a concentration of an analyte using at least the signal and the respective value specific to the droplet generator that formed the emulsion.

### BRIEF DESCRIPTION OF THE DRAWINGS

FIG. 1 is a schematic view of an exemplary droplet assay system with automatic calibration, in accordance with aspects of the present disclosure.

FIG. 2 is a partially exploded view of an exemplary package containing a fluid consumable for the droplet assay system of FIG. 1, in accordance with aspects of the present disclosure.

FIG. 3 is an isometric view of an exemplary cartridge for the droplet assay system of FIG. 1.

FIG. 4 is an exploded isometric view of the cartridge of FIG. 3.

FIG. 5 is a fragmentary, schematic plan view of the cartridge of FIG. 3 showing an exemplary droplet generator and fluidically-connected reservoirs.

FIG. 6 is a schematic view of an exemplary detection system for the droplet assay system of FIG. 1, with a pipette of the detection system operatively disposed in an emulsion produced and collected by the cartridge of FIG. 3, in accordance with aspects of the present disclosure.

FIG. 7 is a flowchart listing exemplary steps that may be conducted in a method of performing a droplet assay with automatic calibration, in accordance with aspects of the present disclosure.

FIG. 8 is a fragmentary, schematic plan view of the cartridge of FIG. 3 showing four droplet generators and an emulsion being formed by each droplet generator and collected in a respective well of the cartridge, with a difference in size of droplets among the emulsions grossly exaggerated to illustrate a problem with variation in droplet size that is addressed by aspects of the present disclosure.

FIG. 9 is a graph of exemplary concentration data from experiments performed with four working copies of an injection-molded cartridge, and showing reproducible, position-specific variation of the concentration among the copies, in accordance with aspects of the present disclosure.

FIG. 10 is a flowchart listing exemplary steps that may be conducted in a method of performing a droplet assay with automatic adjustment of the calculated analyte concentration based on calibration data associated with a cartridge tag, in accordance with aspects of the present disclosure.

FIG. 11 is a flowchart listing exemplary steps that may be conducted in a method of performing a droplet assay with automatic adjustment of pressure for droplet formation based on calibration data associated with a consumable, in accordance with aspects of the present disclosure.

FIG. 12 is a flowchart listing exemplary steps that may be conducted in a method of performing a droplet assay with automatic adjustment of pressure based on a measured operating condition, in accordance with aspects of the present disclosure.

FIG. 13 is a flowchart listing exemplary steps that may be conducted in a method of performing a droplet assay in which two distinct volumes for the droplets of each emulsion are calculated, namely, an encapsulation-based volume (V_{END}) and a detection-based volume (V_{DET}), in accordance with aspects of the present disclosure.

FIG. 14 is a graph plotting the deviation of calculated target concentration for replicate emulsions, as a function of the average detected signal width of droplets of each emulsion, with signal detection performed by the same physical embodiment of a detection system at two different temperatures (20° C. or 32° C.), in accordance with aspects of the present disclosure.

### DETAILED DESCRIPTION

The present disclosure provides systems and methods for performing droplet assays with automatic calibration. An exemplary assay system may comprise a cartridge including a plurality of droplet generators to form emulsions of droplets having a same nominal volume. A tag may be associated with the cartridge and may encode calibration data or an identifier thereof. The calibration data may include a respective value specific to each droplet generator (relative to other droplet generators of the same cartridge). The system further may include a detection system to detect a signal representing an analyte from droplets of each emulsion, and a reader to read the calibration data or the identifier from the tag. The system still further may include a processor configured to receive the signal and the calibration data and to calculate, for each emulsion, a concentration of an analyte using at least the signal and the respective value specific to the droplet generator that formed the emulsion.

Methods of performing an assay with droplets are provided. In an exemplary method, emulsions may be formed with a plurality of droplet generators provided by a cartridge. Droplets of the emulsions may have a same nominal volume. A signal representing an analyte may be detected from droplets of each emulsion. A tag associated with the cartridge may be read to obtain calibration data including a respective value specific to each droplet generator, or to obtain an identifier for the calibration data. The calibration data may be received with a processor. A concentration of the analyte may be calculated for each emulsion with the processor using at least the signal and the respective value specific to the droplet generator that formed the emulsion.

Methods of manufacturing a cartridge for droplet generation are provided. In an exemplary method, copies of a cartridge may be produced. Each copy may include a plurality of droplet generators configured to form droplets of a same nominal volume. One or more of the copies may be tested to obtain a respective value specific to each droplet generator. The respective value may be related to a droplet volume for the droplet generator. A plurality of the copies may include a tag, and the tag may encode the value specific to each droplet generator or an identifier thereof.

Another exemplary droplet assay system is provided. The system may comprise a cartridge including a plurality of droplet generators. The system also may comprise a carrier fluid and an aqueous mixture. The system further may comprise a tag associated with the cartridge, the carrier fluid, or the aqueous mixture. The system even further may comprise a reader configured to obtain calibration data or an identifier thereof from the tag. The system may include an encapsulation system configured to receive the cartridge, the carrier fluid, and the aqueous mixture, and to apply positive/negative pressure that drives formation of an emulsion by each droplet generator. The system may comprise a detection system and a processor. The detection system may be configured to detect a signal from droplets of each emulsion. The processor may be configured to receive the calibration data and generate a control signal for at least one positive/negative pressure source of the encapsulation system based on at least one calibration value of the calibration data.

Still another exemplary droplet assay system is provided. The system may comprise a cartridge including a plurality of droplet generators. The system also may comprise an encapsulation system configured to receive the cartridge and drive formation of an emulsion by each droplet generator. The system further may comprise a detection system including a detector configured to detect a signal from droplets of each emulsion. The system still further may comprise a sensor and a processor. The sensor may be configured to measure a temperature or an atmospheric pressure. The processor may be configured to control operation of the encapsulation system and/or the detection system with an adjustment based on the measured temperature or atmospheric pressure.

An exemplary method of determining a volume of droplets is provided. In the method, a signal may be detected from droplets with a detector as the droplets pass through a detection zone. An average signal width for droplets may be calculated from the signal. A volume of the droplets may be calculated based on the average signal width. Each step of calculating may be performed with a processor.

Yet another exemplary method of performing an assay is provided. In the method, one or more signals may be detected from droplets with at least one detector as the droplets pass through a detection zone. A value corresponding to a volume of the droplets may be calculated based on at least one of the signals. A concentration of an analyte in the droplets may be calculated based at least in part on one of the one or more signals and the value corresponding to a volume of the droplets. Each of the steps of calculating may be performed with a processor.

Yet still another exemplary method of performing an assay is provided. In the method, droplets may be generated at a channel intersection of a droplet generator. One or more signals may be detected from the droplets with at least one detector as the droplets pass through a detection zone. A first value may be obtained with a processor. The first value may correspond to a generation-based volume of the droplets. A second value may be calculated with the processor using at least one signal of the one or more signals. The second value may correspond to a detection-based volume of the droplets. A final volume for the droplets may be calculated using at least the first value and the second value. A concentration of an analyte in the droplets may be calculated based on a signal of the one or more signals and the final volume.

Droplet assays present a variety of challenges. A substantial amount of money and effort can be required to achieve a consistent droplet size from droplet generators of a cartridge, an aqueous reagent mixture, and a carrier fluid. As the size of generated droplets is reduced, mechanical cartridge variations can have a greater impact on droplet sizing errors. Also, lot-to-lot differences in physical properties of the aqueous reagent mixture and carrier fluid can affect droplet size. Furthermore, fluctuations in ambient temperature and pressure can affect the size of droplets generated or the apparent size of droplets when a signal is detected from the droplets.

Approaches are available for reducing errors in droplet size. For example, a mold insert (a tool) for molding a channel portion of a cartridge can be machined to very tight tolerances, or possibly re-machined and adjusted according to the performance of the cartridge. However, tight machining tolerances or rework steps only apply to the cartridge and not other consumables, only rescue a fraction of tools, and introduce a significant cost for re-machining and re-qualification of each tool. Another approach is to form droplets in the presence of a non-reactive “fiducial” dye, and to detect a size signal from the dye. However, this approach reduces the number of detection wavelengths available for analyte signals. Alternatively, droplets can be sized optically without a fiducial dye, but the droplet size can change substantially between formation and detection (e.g., if droplets are thermally cycled). Yet other approaches involve very stringent control over manufacturing materials and procedures, loosened specifications for accuracy, or generation of larger droplets. All of these approaches have merit in some situations but are deficient in others.

The present disclosure provides a new approach to increasing the accuracy of droplet assays with “smart” consumable calibration. Systems and methods disclosed herein include one or more consumables associated with calibration data. The calibration data may indicate, for a given unit (or copy) of the consumable (e.g., a cartridge), how the unit differs from a nominal design and/or responds to changes in operating conditions. The calibration data may be the same for each unit (or copy) of a production lot of the consumable. Each unit of the lot may carry a tag, such as a barcode or RFID tag, readable by an instrument to obtain the calibration data. At least one ambient condition may be measured. Calibration data encoded or identified by the unit and/or a value(s) for the ambient condition(s) may be factored into either control (e.g., droplet generation pressure) or analysis (e.g., droplet size used in calculating concentration).

A mold to form a molded portion of a cartridge may include an insert (a tool) defining ridges. The ridges may create complementary open channels of droplet generators in the molded portion, which then may be closed (circumferentially bounded) with a cover, such as a bonded film. The ridges typically need to be evaluated to determine whether the insert meets specifications. This evaluation can be performed by functionally testing one or more copies of a molded cartridge(s) in which the channels are produced by the ridges. Based on test results, the insert may be accepted, reworked, or scrapped. A significant number of inserts may not be acceptable.

In the present disclosure, data from functional testing of one or more copies of a molded cartridge or one or more units of another consumable may be used to make corrections that can be coded onto other copies/units of the cartridge consumable and later into corresponding metadata to be used during signal processing. Thus, consumables that are physically out of desired tolerance can be rendered acceptable by having their data numerically corrected into tolerance.

The systems and methods of the present disclosure may offer various advantages. Concentration accuracy may be improved. Emulsions may provide reproducible results beyond what can be achieved physically. Accurate results may be obtained with smaller droplets. Consumables may be produced more cheaply and reliably by accepting more tool and lot-to-lot variation. A larger pool of manufacturers may become available in response to relaxed tolerances for consumables enabled by the present disclosure.

Further aspects of the present disclosure are described in the following sections: (I) overview of droplet assay systems with automatic calibration, (II) consumables and tags, (III) detection system, (IV) methods of performing droplet assays, (V) cartridge calibration, (VI) pressure adjustments, (VII) droplet assays with calculation of a detection-based droplet volume, and (VIII) selected embodiments.

### I. Overview of Droplet Assay Systems with Automatic Calibration

This section provides an overview of droplet assay systems having automatic calibration to adjust pressure that drives fluid flow and/or to computationally correct a concentration value(s) of an analyte(s), as exemplified by droplet assay system 50; see FIG. 1.

Assay system 50 includes an encapsulation system 52 to drive formation of droplets, and a detection system 54 to detect a signal(s) from the droplets. The assay system also has a processor 56 to control operation of systems 52 and 54, indicated by dashed arrows at 58. The processor may be configured to process the detected signal to determine the concentration of an analyte present in the droplets. Encapsulation system 52 and detection system 54 may be provided by a single instrument 60, as shown, or by respective separate instruments, among others.

The assay system may rely on various consumables, such as consumables 62a, 62b, and 62c. The consumables may be received by instrument(s) 60 and then utilized by the instrument(s) during assay performance. Exemplary consumables may, for example, include a cartridge 64 to form and, optionally, collect droplets, a carrier fluid 66 (e.g., oil) for droplet generation (to serve as a continuous phase of an emulsion), a dilution fluid 68 (e.g., oil) to increase droplet separation during signal detection, and a reagent mixture that constitutes a substantial portion (e.g., at least 10%, 20%, or a majority by volume) of each droplet (see Section II).

A “cartridge,” as used herein, is a container to hold fluid (e.g., liquid), such as sample-containing liquid to be dispersed into sample-containing emulsion droplets. The container may interface at least with encapsulation system 52 of instrument 60. As described further below, the cartridge may include at least one or a plurality of droplet generators and a sample reservoir, such as a sample well, in fluid communication with at least one of the droplet generators. In some embodiments, the cartridge may have a respective sample reservoir, such as a respective sample well, in fluid communication with each droplet generator. The cartridge may or may not include one or more other reservoirs (e.g., one or more carrier wells) to hold at least one immiscible carrier liquid that is supplied to the droplet generators during emulsion formation, to provide a continuous phase of each emulsion. The cartridge also may or may not have respective reservoirs, such as respective droplets cells, to collect each emulsion formed by the droplet generators.

One or more of the consumables may be associated with a tag 70, and system 50 may be equipped with a reader 72 (interchangeably termed a detector) to read (detect) information encoded by the tag. The information may include calibration data (e.g., one or more calibration values) encoded by the tag and corresponding to the particular serial number or lot number of the consumable. Alternatively, or in addition, the information may include an identifier of the calibration data, such as by identifying the consumable itself (e.g., according to serial number and/or lot number). In some embodiments, once the consumable is identified, corresponding calibration data (e.g., one or more calibration values) for that particular instance, serial number, and/or lot number of the consumable can be acquired from a different location, such as a remote location accessible via a computer network 74 (e.g., the Internet). Accordingly, processor 56 may receive calibration data for the consumable from reader 72, or from a database of network 74 based on consumable-identifying information received from reader 72, among others. Any suitable portion of the calibration data may be utilized by processor 56 to adjust an operating parameter(s) of system 50 and/or to apply a correction when analyte concentrations are being calculated.

Assay system 50 also or alternatively may incorporate at least one environmental sensor 76 (interchangeably termed an ambient sensor) to detect one or more ambient conditions (also called operating conditions). Exemplary ambient conditions that may affect droplet generation in system 52 or signal detection in system 54 include temperature and atmospheric pressure, among others. The ambient sensor may create an ambient signal representing the measured ambient condition, and the ambient signal may be communicated to processor 56. The processor may adjust an operating parameter of system 50 (e.g., a pressure that drives fluid flow), and/or may apply a correction when analyte concentrations are being calculated, using the ambient signal. Encapsulation system 52 may include an encapsulation pressure controller 78 that creates a pressure differential to drive fluid flow into, within, and/or out of cartridge 64. In exemplary embodiments, the pressure controller drives flow of carrier fluid 66 into the cartridge, and flow of the carrier fluid and a dispersed phase through droplet generators of the cartridge for collection as emulsions in wells of the cartridge. The pressure controller may include at least one source of positive pressure or negative pressure (vacuum). The source may include at least one pump 80, one or more valves 82, one or more conduits 84, a chamber to hold a positive or negative pressure (e.g., generated by the pump or off-line), a manifold 86 to distribute pressure across the cartridge for each droplet generator, or any combination thereof, among others. The source may apply pneumatic and/or hydraulic pressure to the cartridge and/or to fluid held by the cartridge. The pressure may be applied and/or adjusted via the at least one pump, the one or more valves, and/or the like. Calibration data associated with a tag(s) 70, and/or an environmental signal, may be used to calibrate pressure controller 78 for better correspondence with the particular consumables present in the system and/or with a current ambient condition for system 50. In some embodiments, manifold 86 may be omitted, and pressure to each of the droplet generators may be controlled individually. Further aspects of exemplary encapsulation systems are described elsewhere herein and in the patent applications listed above under Cross-References and incorporated herein by reference, particularly U.S. Patent Application Publication No. 2012/0152369 A1, published Jun. 21, 2012.

Detection system 54 may include a detection pressure controller 88 that creates a pressure differential to drive fluid flow out of cartridge 64 (or a different container), and through a detection volume 90 (also called a detection zone) formed by a region of a detection channel 91. A signal may be detected from the detection volume by a detector 92 as droplets and carrier fluid from the cartridge pass through. The pressure controller may comprise and/or drive a pipette 94 that aspirates emulsions from the cartridge. Pressure controller 88 also may create a pressure differential that drives flow of dilution fluid 68 into contact with the aspirated emulsion, to dilute the emulsion, thereby increasing the spacing between droplets before the droplets pass through detection channel 91. Furthermore, pressure controller 88 may create a pressure differential that drives droplets and the surrounding carrier/dilution fluid from detection channel 91 to waste. The pressure controller may include at least one source of positive pressure or negative pressure (vacuum) (such as at least one pump 96), one or more valves, one or more conduits, a chamber (e.g., a vacuum container) to hold a positive or negative pressure generated by the pump, or the like. Calibration data associated with a tag(s) 70, and/or an ambient signal, may be used to calibrate detection pressure controller 88 for better correspondence with the particular consumables present in the system and/or the current ambient condition for system 50. Further aspects of exemplary detection systems are described elsewhere herein, such as in Section III, and in the patent applications listed above under Cross-References and incorporated herein by reference, particularly U.S. Patent Application Publication No. 2012/0190033 A1, published Jul. 26, 2012.

Cartridge 64 and pipette 94 may move relative to one another after the process of encapsulation and before the process of detection. For example, the cartridge (and/or emulsions therein) may be relocated from an encapsulation station to a detection station of instrument 60 (or to a separate detection instrument), indicated by an arrow at 98 and a phantom cartridge 64 in detection system 54, after droplet formation and before detection. Emulsions held by cartridge 64 may be heated (e.g., thermally cycled) by a heater 100 in the encapsulation station or the detection station to promote a reaction, such as an amplification reaction (e.g., PCR). Alternatively, heater 100 may be located in a separate heating station, which may be provided by instrument 60 or a separate instrument. Accordingly, in some embodiments, cartridge 64 and/or emulsions formed therein may be moved among an encapsulation station, a heating station, and a detection station. In some embodiments, the cartridge may remain stationary after the encapsulation process, and pipette 94 may be moved to the cartridge to initiate emulsion aspiration and passage of droplets through detection channel 91. In some embodiments, emulsions may be removed from cartridge 64 and placed into a separate holder after droplet formation and before heating and/or signal detection.

Processor 56 may include any suitable combination of electronic components to achieve coordinated operation and control of system functions. The electronic components may be disposed in one site or may be distributed to different areas of the system. The processor may include one or more electronic/digital processing devices for data processing and also may include additional electronic components to support and/or supplement the processing devices, such as switches, amplifiers, filters, analog to digital converters, busses, one or more data storage devices to provide memory, etc. In some cases, the processor may include at least one master control unit in communication with a plurality of subordinate control units. In some cases, the processor may include a computer, which may be a built-in computer, a desktop computer, a laptop computer, or the like. The processor may include or be connected to any suitable user interface(s), such as a display, a keyboard, a touchscreen, a mouse, etc.

Further aspects of exemplary droplet assay systems are described elsewhere herein and in the patent applications listed above under Cross-References and incorporated herein by reference, particularly U.S. Patent Application Publication No. 2010/0173394 A1, published Jul. 8, 2010.

### II. Consumables and Tags

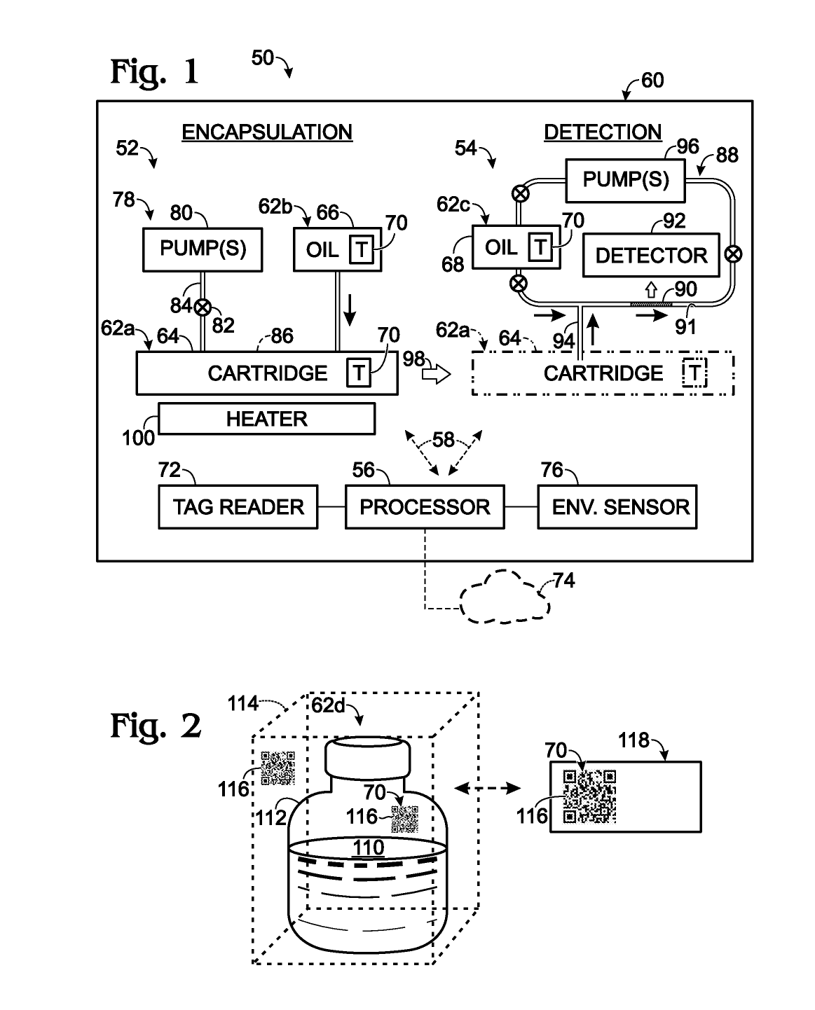

This section describes exemplary consumables for the droplet assay system of Section I, including exemplary tags associated with the consumables; see FIGS. 2-5.

A “consumable,” as used herein, is any article or material intended to be replaced after limited use (e.g., a single use) or depletion. Consumables 62 utilized in assay system 50 may include a single-use device (e.g., cartridge 64) that forms droplets in emulsions (see FIG. 1). The consumables also or alternatively may include one or more fluids/liquids (e.g., carrier fluid 66, an aqueous reagent mixture, etc.) that constitute at least a portion of the droplets and/or emulsions. The consumables also or alternatively may include one or more fluids/liquids (e.g., dilution fluid 68) that contact the emulsions and/or droplets.

A “tag,” as used herein, may be any member or region containing calibration information, which may be encoded. A tag is “associated” with a consumable if the tag and the consumable are supplied together to a user, such as with the tag connected to the consumable. The tag may be formed separately and then attached to the consumable, such as by bonding, with an adhesive, or the like. In other embodiments, the tag may be formed on the consumable, such by printing, etching, or engraving. Accordingly, the tag may be carried by the consumable. In yet other embodiments, the tag may not be connected to the consumable and may be provided, for example, by a packaging material or a package insert for the consumable (see below).

The tag, and particularly information encoded by the tag, may be configured to be detectable by any suitable reader. The tag may be optically detectable, such as with a barcode reader, or detectable with a radio-frequency identification (RFID) reader, among others. Accordingly, the tag may, for example, be a barcode (e.g., a one-dimensional or two-dimensional barcode), an active or passive RFID tag, or the like. The reader may read the tag automatically when the tag is operatively positioned with respect to the detector. For example, the reader may read the tag when the associated consumable is operatively disposed in instrument 60, and/or when the tag is placed within the detection range or viewing field of the reader. Alternatively, the user may input a signal to the reader when the tag is positioned suitably for reading. In some embodiments, the user may enter calibration information for at least one consumable to a processor, rather than having the information read by a reader.

The tag may contain any suitable information. The information may include an identifying code, such as a manufacturer's serial number or lot number for the associated consumable. The identifying code may allow additional information about the consumable, such as calibration data (or revised calibration data), to be obtained from a remote database. The information encoded (or identified) by the tag also may include one or more calibration values. Each calibration value may correspond to the production lot to which the particular consumable belongs, and may relate to a physical property or a characteristic of the consumable or a region thereof (e.g., a particular droplet generator) for that lot. The calibration value may, for example, be a lot-specific value for the physical property or characteristic. In any event, the calibration value may allow the processor of the instrument to apply a lot-specific adjustment to an operating condition of the instrument and/or to a concentration calculation.

A “lot” or “production lot,” as used herein, is a defined quantity of units (e.g., copies) of a manufactured item. Units of the item in a lot are of a single class, composition, model, size, type, and/or version, are generally produced under essentially the same conditions with the same material(s) by a single manufacturer, and are intended to have uniform quality and characteristics within specified limits. A lot may, for example, be ordered, sold, released, or delivered in its entirety.

Exemplary tags for consumables of the system may provide or identify any suitable information. An exemplary tag for a manufactured unit of cartridge 64 may include a serial number or lot number, and/or a nominal droplet volume for the entire cartridge (i.e., for all of the droplet generators collectively). The tag also or alternative may include, for each droplet generator, any combination of the following: a generator-specific nominal value for droplet volume, a nominal sample run time, and/or a nominal generation volume. A “nominal” value for a characteristic, such as a nominal droplet volume for the cartridge or a particular droplet generator thereof, is the value expected or predicted, generally under a standard or reference set of predefined operating conditions, and may be approximate. For example, the nominal droplet volume for the entire cartridge is the approximate droplet volume expected to be generated by each droplet generator of the cartridge under standard/reference operating conditions. A generator-specific nominal droplet volume is the droplet volume expected to be generated by a particular droplet generator of the cartridge under standard/reference operating conditions, and, because the value for the droplet volume is specific to the particular droplet generator, is generally more accurate than the nominal droplet volume for the entire cartridge. In some embodiments, a nominal value may be adjusted by the assay system when the actual operating conditions are different from standard/reference operating conditions.

An exemplary tag for a unit of carrier fluid 66 may include any combination of the following: a serial number or lot number, a droplet volume correction (e.g., a correction factor), a droplet volume correction temperature sensitivity, and/or a droplet volume correction pressure sensitivity. An exemplary tag for a unit of dilution fluid 68 may include any combination of the following: a serial number or lot number, viscosity, a viscosity temperature sensitivity, density, and/or a density temperature sensitivity. An exemplary tag for a unit of a reagent mixture (see below) may include any combination of the following: a serial number or lot number, a droplet volume correction (e.g., a correction factor), a droplet volume correction temperature sensitivity, a droplet volume correction pressure sensitivity, a run time correction, a run time correction temperature sensitivity, a run time correction pressure sensitivity, a generation volume correction, a generation volume correction temperature sensitivity, and/or a generation volume correction pressure sensitivity.

FIG. 2 shows an exemplary consumable 62d including an aqueous reagent mixture 110 for assay system 50. Consumable 62d may be supplied as a unit including a vessel 112 to contain mixture 110. The vessel may be enclosed by a container 114 (e.g., a box or bag), shown here in phantom outline, to form a package. The consumable may be associated with a tag 70 presenting a barcode 116 that encodes and/or identifies calibration data. The barcode may be attached to vessel 112, container 114, and/or an insert 118 (e.g., a card) of the package. Insert 118 is shown in FIG. 2 after removal from container 114, as indicated by a dashed, double-headed arrow. The presence of barcode 116 on container 114 and/or insert 118 allows a user to manually place the barcode in reading proximity of tag reader 72, while vessel 112 and its contents remain remote from instrument 60. This configuration may be desirable to reduce the risk of contamination. Any combination of the features described here for consumable 62d and its relation to tag 70 may be suitable for other consumables of the assay system, particularly units of other consumable fluids.

Mixture 110 may form at least a portion (e.g., at least 10% by volume) of the dispersed phase of each emulsion formed. Mixture 110 may, for example, contain any combination of water, buffer, dNTPs, surfactant, an enzyme (e.g., a heat-stable polymerase), an intercalating dye, and/or one or more divalent cations, among others. In some embodiments, the mixture may be configured to be supplemented by a user, such as with any combination of primers, a labeled probe, a sample containing an analyte, additional water, and/or the like.

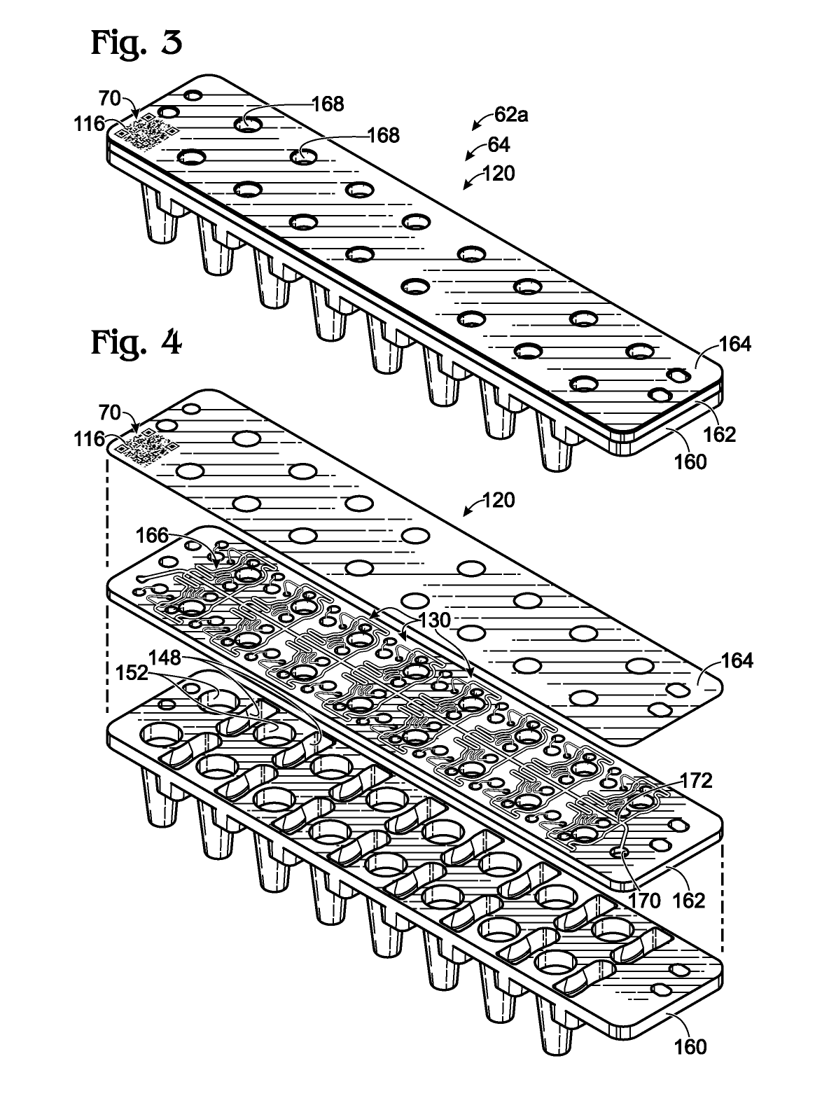

FIGS. 3 and 4 show respective assembled and exploded views of an exemplary embodiment 120 of cartridge 64 for assay system 50. Cartridge 120 provides an array of emulsion production units 130 each configured to form and collect a separate emulsion of droplets disposed in a carrier fluid. Sixteen units 130 are present in cartridge 120, but in other embodiments the cartridge may have any suitable number of the units. A tag 70, such as a barcode 116, may be carried on the top side, as depicted, or on any other suitable side of cartridge 120.

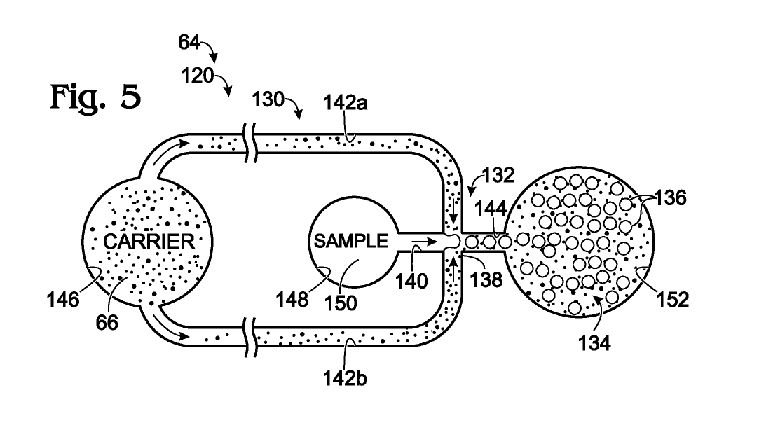

FIG. 5 shows one of emulsion production units 130 schematically. Unit 130 includes a droplet generator 132 that forms an emulsion 134 of droplets 136. The droplet generator may be created by a channel intersection 138 formed by a sample input channel 140, at least one carrier input channel (channels 142a and 142b are shown here), and a droplet output channel 144. The droplet generator may be in fluid communication with a carrier reservoir 146 containing carrier fluid 66, a sample reservoir (e.g., a sample well 148) holding a sample 150 (also called a sample-containing phase or liquid) to be dispersed into droplets 136, and a collection reservoir (e.g., an emulsion well 152) configured to receive and collect emulsion 134. Carrier reservoir 146 supplies carrier fluid via a manifold to a plurality of units 130 in the depicted embodiment, or may be a dedicated carrier well for only a single unit 130, among others.

FIGS. 3 and 4 illustrate an exemplary construction for channels and wells of cartridge 120 (also see FIG. 5). The cartridge may include a well component 160, a channel component 162, and a cover 164. The well component defines sample wells 148 and emulsion wells 152. The channel component alone defines open channels (grooves) corresponding to channels 140, 142a, 142b, and 144 of each unit 130, indicated generally by an arrow at 166. Cover 164 may be a sheet of material, such as a film, that is attached to channel component 162 to close the open channels defined by the channel component. In other words, the cover may, for example, form a ceiling for the channels. Components 160, 162 may be formed separately from one another and then attached (e.g., bonded) to one another, or may be formed integrally with one another as a single piece. In any event, the wells and channels of the cartridge may be molded, for example, injection-molded, to form a molded portion of the cartridge. In other embodiments, the channels may be formed near the bottom of the wells, and cover 164 may form the floor of the channels.

Samples 150 may be loaded into sample wells 148 of cartridge 120 through ports 168 (see FIGS. 3-5). Carrier fluid may be supplied from a reservoir off-cartridge via a carrier port 170 that communicates with a carrier manifold 172. The manifold is fluidically connected to each carrier channel 142a, 142b. A vacuum may be applied with pressure controller 78 through openings created by puncturing cover 164, to form emulsions collected in emulsion wells 152 (also see FIG. 1). Further aspects of cartridges, including cartridge 120, are described in the patent applications listed above under Cross-References, which are incorporated herein by reference, particularly U.S. Patent Application Publication No. 2014/0378348 A1, published Dec. 25, 2014.

### III. Detection System

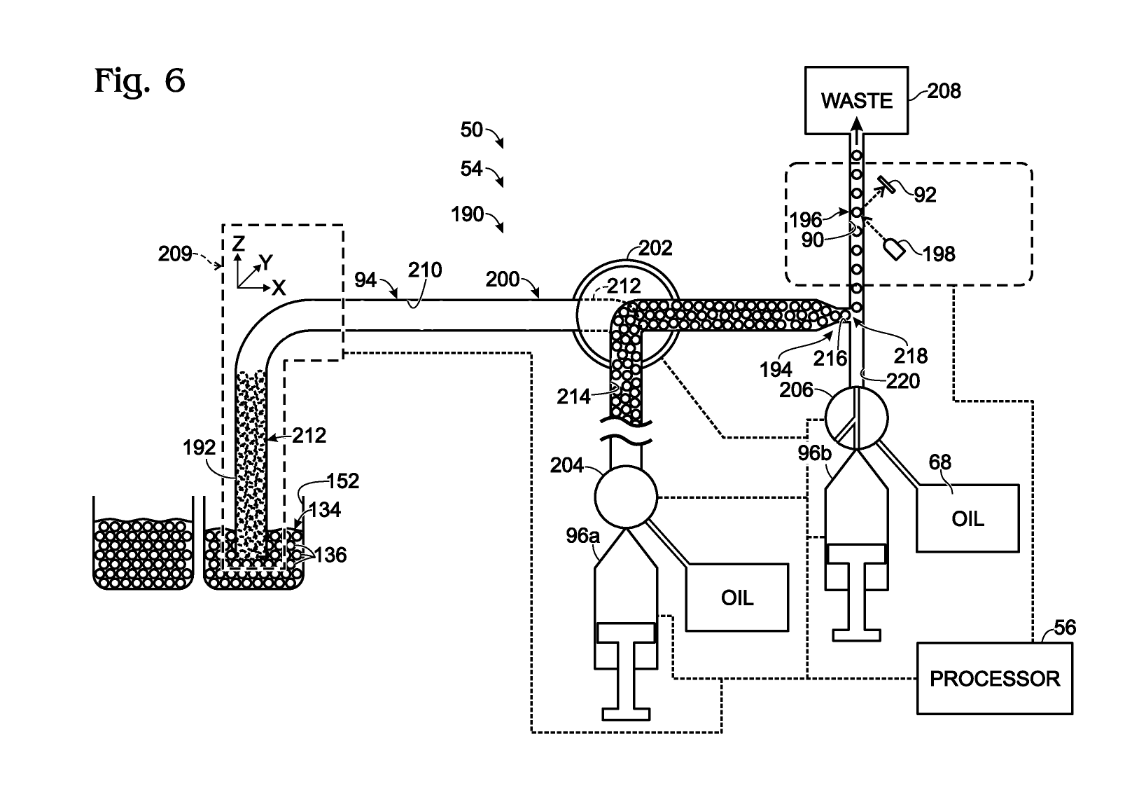

This section describes further aspects of an exemplary detection system 54 for droplet assay system 50 of Section I; see FIG. 6.

Detection system 54 may be equipped with a transport system 190 including pipette 94. The pipette has a tip 192 to pick up droplets 136 in an emulsion 134 held by emulsion well 152 (also see FIGS. 3-5). The droplets may be queued and separated in a droplet arrangement region 194, and then conveyed serially through an examination site 196 that includes detection volume 90 (interchangeably called a detection zone), for detection of a signal from the droplets with detector 92 (also see FIG. 1). The detector may be operatively disposed with respect to a light source 198 that irradiates examination site 196 and fluid/droplets therein. Detector 92 may be a photodetector that detects light received from the irradiated examination site (and the fluid/droplets therein) and creates a signal representative of the detected light. The photodetector may convert photons into an electrical signal (electrical current and/or voltage). Light detection and signal creation considered collectively may be described as signal detection. “Light,” as used herein, may include ultraviolet radiation, visible light, and/or infrared radiation. In other embodiments, the detector may, for example, detect a different type of radiation, an electrical property, a magnetic property, or the like. Detection and signal creation collectively, whether or not performed optically, are described herein as signal detection.

The transport system may include a channel network 200 connected to tip 192. The transport system may include channel-forming members (e.g., tubing and/or one or more planar members) and at least one valve (e.g., valves 202, 204, 206, which may include valve actuators) to regulate and direct fluid flow into, through, and out of the channel network. Fluid flow into, through, and out of channel network 200 may be driven by at least one pump, such as an emulsion pump 96a and a dilution pump 96b. The fluid introduced into channel network 200 may be supplied by emulsion 134 and dilution fluid 68. The dilution fluid may be a hydrophobic fluid (e.g., oil), which may be miscible with the continuous phase, but not the dispersed phase of the emulsion. Fluid that travels through examination site 196 may be collected in one or more waste receptacles 208.

A channel network may be any fluidics assembly including a plurality of channels. A channel network may, for example, include any combination of channels (e.g., formed by tubing, planar members, etc.), one or more valves, one or more chambers, one or more pumps, fluid sources, etc.

The carrier fluid and/or dilution fluid may include an oil and/or an oil phase. Exemplary oils may include at least one silicone oil, fluorine-containing oil, mineral oil, vegetable oil, or a combination thereof, among others. An oil phase may include one or more surfactants.

Each pump may have any suitable structure capable of driving fluid flow. The pump may, for example, be a positive-displacement pump, such as a syringe pump, among others. Other exemplary pumps include peristaltic pumps, rotary pumps, or the like.

The position of tip 192 may be determined by a drive assembly 209 capable of providing relative movement of the tip and emulsion well 152 along one or more axes, such as three orthogonal axes in the present illustration. In other words, the drive assembly may move the tip while the emulsion well remains stationary, move the emulsion well while the tip remains stationary, or move both the tip and the emulsion well at the same or different times, among others. In some embodiments, the drive assembly may be capable of moving the tip into alignment with each emulsion well of the cartridge, lowering the tip into contact with an emulsion in the emulsion well, and raising the tip above the emulsion well to permit movement of the tip to another emulsion well. The drive assembly may include one or more motors to drive tip/emulsion-well movement, and one or more position sensors to determine the current position of the tip and/or emulsion well and/or changes in tip/emulsion-well position. Accordingly, the drive assembly may offer control of tip position in a feedback loop.

Detection system 54 may be under control of processor 56. The processor may control operation of, receive inputs from, and/or otherwise communicate with any other components of the transport system. For example, the processor may control light source operation and monitor the intensity of light generated, adjust detector sensitivity (e.g., by adjusting the gain), process the signal received from the detector (e.g., to identify droplets and determine analyte concentrations), and so on. The processor also or alternatively may control valve positions, tip movement (and thus tip position), pump operation (e.g., pump selection, direction of flow (i.e., generation of positive or negative pressure), rate of flow, volume dispensed, etc.), and/or the like. Accordingly, the processor may control when, where, and how fluid moves within the channel network 200. The processor may provide automation of any suitable operation or combination of operations. Accordingly, the transport system may be configured to load and detect a signal from a plurality of emulsions automatically without user assistance or intervention.

Tip 192 may form part of an intake channel or loading channel 210 that extends into channel network 200 from tip 192. Droplets 136 may enter other regions of the channel network from loading channel 210. The droplets in emulsion 134 may be introduced into loading channel 210 via tip 192 (i.e., picked up by the tip) by any suitable active or passive mechanism. For example, emulsion 134 may be pulled into the loading channel by a negative pressure created by a pump, i.e., by suction (also termed aspiration), may be pushed into the loading channel by a positive pressure applied to emulsion 134 in emulsion well 152, may be drawn into the loading channel by capillary action, or any combination thereof, among others.

In exemplary embodiments, pump 96a pulls the emulsion into loading channel 210 by application of a vacuum. To achieve loading, valve 202 may be placed in a loading position, indicated in phantom at 212, to provide fluid communication between tip 192 and pump 96a. The pump then may draw the emulsion, indicated by phantom droplets at 212, into loading channel 210 via tip 192, with the tip in contact with the emulsion. The pump may draw the loaded droplets through valve 202 into a holding channel 214.

The loaded droplets may be moved toward examination site 196 by driving the droplets from holding channel 214, through valve 202, and into a queuing region 216. The queuing region may place the droplets in single file.

The droplets may enter a confluence region or separation region 218, optionally in single file, as they emerge from queuing region 216. The confluence region may be formed at a junction of the queuing region and at least one dilution channel 220. The dilution channel may supply a stream of dilution fluid 68 driven through confluence region 218, as droplets and carrier fluid enter the confluence region as a stream from queuing region 216. The dilution fluid may be miscible with the carrier fluid and serves to locally dilute the emulsion in which the droplets are disposed, thereby separating droplets by increasing the average distance between droplets. The droplets may enter detection volume 90 after they leave confluence region 218.

Tip 192 may be utilized to load a series of emulsions from different emulsion wells. After droplets are loaded from a first emulsion well, the tip may be lifted to break contact with remaining fluid, if any, in the emulsion well. A volume of air may be drawn into the tip to serve as a barrier between sets of loaded droplets and/or to prevent straggler droplets from lagging behind as the droplets travel through the channel network. In any event, the tip next may be moved to a wash station, where tip 192 may be cleaned by flushing, rinsing, and/or immersion. More particularly, fluid may be dispensed from and/or drawn into the tip at the wash station, and the tip may or may not be placed into contact with a fluid in the wash station during cleaning (e.g., decontamination). The cleaned tip then may be aligned with and lowered into another emulsion well, to enable loading of another emulsion.

### IV. Methods of Performing Droplet Assays

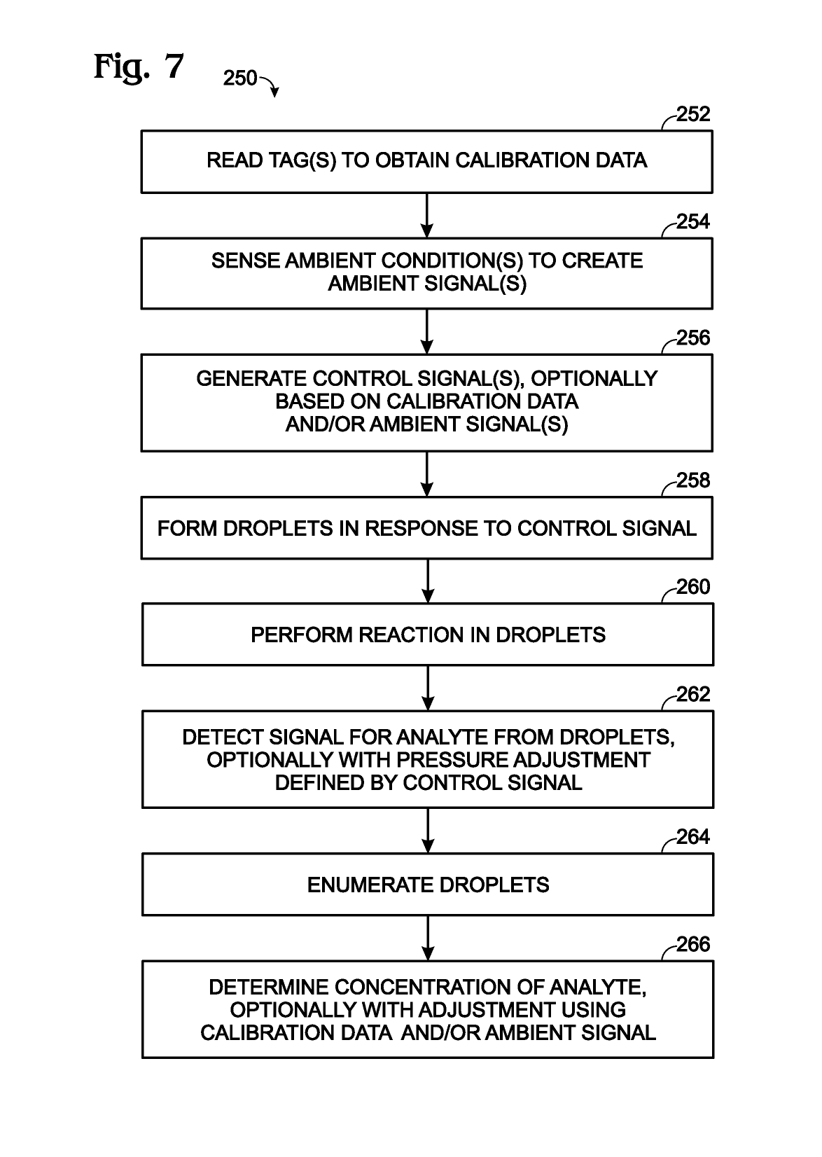

This section provides an overview of an exemplary method 250 of performing a droplet assay with automatic calibration; see FIG. 7. The method steps presented in this section may be performed in any suitable order and combination, and may be modified or supplemented with any other suitable aspects of the present disclosure. Each of the steps disclosed in Sections IV to VI is optional.

A tag(s) associated with a consumable(s) may be read by a reader to obtain calibration data, indicated at 252. The tag may be attached to the consumable or packaged with the consumable, among others. Reading may be performed automatically, before or after the consumable is operatively loaded by a user into an assay instrument, or may involve manual positioning of the tag near a tag reader, separate from operative loading of the consumable. The calibration data may be obtained directly from the tag when the tag is read, or may be identified by the tag and obtained from a local database (e.g., stored in memory of an assay instrument) or a remote database (e.g., by downloading the calibration data from a network). In any event, a processor receives the calibration data as result of reading the tag. Further aspects of tags, consumables, calibration data, and tag readers that may be suitable are described elsewhere herein, such as Section II.

An ambient condition(s) may be measured to create an ambient signal(s), indicated at 254. The ambient condition may be measured inside or outside an assay instrument. Accordingly, the ambient condition may be ambient for an internal environment and/or an external, surrounding environment of the instrument. The ambient condition may, for example, be temperature, atmospheric (air) pressure, humidity, or the like.

A control signal for droplet formation may be generated, indicated at 256. The control signal may be generated by a processor with an algorithm and communicated to a pressure controller of an encapsulation system, and may control operation of the pressure controller. The control signal may, for example, control a negative or positive pressure exerted by the pressure controller on a cartridge, and/or on fluid held by and/or in fluid communication with the cartridge. The control signal may affect the magnitude, duration, profile (with respect to time), and/or the like of the pressure exerted.

The control signal may be a standard (default) control signal or an adjusted control signal. A standard control signal incorporates no adjustment for calibration data obtained from or identified by a consumable-associated tag, and no adjustment for a difference between a measured value for an ambient condition and a standard value for the ambient condition. An adjusted control signal incorporates one or more adjustments based on calibration data and/or a measured ambient condition, and results in an adjustment to the operation of the pressure controller relative to standard operation thereof. The adjustment may be applied uniformly to the emulsion production units of a cartridge, if, for example, pressure is applied via a manifold to all of the units. Alternatively, the adjustment may include a separate adjustment of the pressure applied to each emulsion production unit, if a separate pressure is applied to each unit individually.

Droplets may be formed in response to the control signal, indicated at 258. The droplets may represent a plurality of separate sets of droplets, each present in a corresponding separate emulsion. The sets of droplets (and the emulsions) may be formed in parallel or in series, among others. Each droplet may have any suitable size, such as less than one millimeter in diameter and/or less than one microliter in volume. Generally, more accurate and precise results can be obtained in assays with a consistent and reproducible size of droplet present within each emulsion and among the emulsions. Accordingly, the droplets of each set may have the same nominal volume, which is the stated or approximate size of the droplets of all of the emulsions of a cartridge considered collectively. In other words, the droplets of each emulsion may have substantially the same size as the droplets of each other emulsion formed by a cartridge. Two sets of emulsion droplets having substantially the same size may have respective average volumes that differ by less than about 50%, 25%, 20%, 15%, or 10%, among others. Sets of droplets having substantially the same size may be formed with a cartridge having a plurality of droplet generators that are copies of one another (i.e., substantially identical to one another) and/or that have substantially the same channel dimensions near a channel junction at which droplets are generated. In some embodiments, each droplet may be an aqueous droplet disposed in an immiscible carrier fluid (e.g., a carrier liquid). The droplets may be formed by any suitable mechanism including flow focusing (e.g., at a cross junction), shearing (e.g., at a T-junction), sonication (e.g., with ultrasound), ejection of fluid into air (e.g., with an inkjet-style mechanism), or the like. In exemplary embodiments, the droplets are formed at a channel intersection at which two, three, four, or more channels meet one another.

The droplets may include an analyte, which is any substance undergoing analysis. The analyte, may for example, be a nucleic acid (e.g., a polynucleotide, such as DNA or RNA), a protein, a peptide, an amino acid, a macromolecular complex, a lipid, an atom, a metal, a hormone, virus particles, biological cells, and/or the like. An analyte may be present at “partial occupancy” in each set of droplets, meaning that only a subset of the droplets of the set contain at least one copy of the analyte. The sets of droplets formed by a cartridge each may contain the same analyte or may contain different analytes.

A reaction may be performed in the droplets, indicated at 260, to enable detection of the analyte's presence. The reaction may, for example, be an enzyme-catalyzed reaction. In exemplary embodiments, the reaction includes an amplification reaction, which may amplify a target sequence of nucleic acid. Amplification may or may not be performed isothermally. In some cases, amplification may be encouraged by heating the droplets and/or incubating the droplets at a temperature above room temperature, such as at a denaturation temperature (e.g., greater than about 90 degrees Celsius), an annealing temperature (e.g., about 50-75 degrees Celsius), and/or an extension temperature (e.g., about 60 to 80 degrees Celsius), for one or a plurality of cycles. In some examples, the droplets may be thermally cycled to promote amplification by a polymerase chain reaction and/or ligase chain reaction, among others. Exemplary isothermal amplification approaches that may be suitable include nucleic acid sequence-based amplification, transcription-mediated amplification, multiple-displacement amplification, strand-displacement amplification, rolling-circle amplification, loop-mediated amplification of DNA, helicase-dependent amplification, and single-primer amplification, among others.

At least one signal may be detected from droplets, indicated at 262. Each signal may be described as an analyte signal that corresponds to the level (e.g., presence or absence) of at least one analyte in individual droplets. The signal may be detected from a label present in the droplets. The label may, for example, be an optically detectable label, such as a photoluminophore (e.g., a fluorophore or a phosphor), among others. Accordingly, the signal may be a photoluminescence signal representing an intensity of light emitted from droplets. Exemplary labels suitable for amplification reactions include fluorophores attached to oligonucleotides, intercalating dyes, and the like.

The signal may be detected from a stream of fluid passing through an examination site of a detection system. The fluid may be driven through the examination site with positive/negative pressure from at least one source of positive/negative pressure of a detection pressure controller. A control signal for the detection pressure controller may be generated by a processor with an algorithm. The control signal may be communicated to the pressure controller of the detection system, and may control operation of the pressure controller. The control signal may, for example, control a positive/negative pressure exerted by the pressure controller on fluid of the fluid stream. The control signal may affect the magnitude, duration, profile (with respect to time), and/or the like of the pressure exerted.

The control signal may be a standard (default) control signal or an adjusted control signal, as described above for droplet generation. Accordingly, a standard control signal incorporates no adjustment for calibration data obtained from or identified by a consumable-associated tag, and no adjustment for a difference between a current value for an ambient condition and a standard value for the ambient condition. An adjusted control signal incorporates one or more adjustments based on calibration data and/or a measured ambient condition, and results in an adjustment to the operation of the pressure controller relative to standard operation thereof.

Droplets may be enumerated, indicated at 264. Enumeration may include determining an analyte content of individual droplets. The analyte content may be a digital or an analog content of one or more analytes.

In some embodiments, a number of droplets positive or negative for each analyte may be determined with the processor using an algorithm. In other words, a number of droplets that are positive for an analyte may be determined, a number of droplets that are negative for the analyte may be determined, or both numbers may be determined. Either or both numbers may be used to calculate concentration, as described below. Droplets positive for an analyte are deemed to contain at least one copy of the analyte based on the at least one signal, and droplets negative for the analyte are deemed to contain no copy of the analyte based on the at least one signal. Assignment of each droplet as positive or negative for an analyte may include comparing a signal value for the droplet to at least one threshold. A total number of droplets may be determined, where the total number corresponds to the sum of the number of droplets positive for an analyte and the number of droplets negative for the analyte.

In some embodiments, one or more calibration values for a consumable may be utilized in the step of droplet enumeration. For example, a calibration value corresponding to a particular droplet generator may affect how droplets produced by that droplet generator are identified in the analyte signal, and/or filtered to exclude droplets that are outside of an acceptable size range. Also or alternatively, the calibration value may affect selection of a suitable threshold(s) to which a signal from each droplet is compared, to assign an analyte content to the droplet.

A concentration of the analyte may be determined (and reported), indicated at 266. The concentration may be calculated with a processor using an algorithm and at least one number of droplets determined by the step of enumerating. In exemplary embodiments, the concentration may be calculated with Equation 1:

C=−ln(Nₙ/Nₜ)÷V_{d} (1)

In Equation 1, C is concentration, Nₙ is the number of negative droplets, Nₜ is the total number of droplets, and V_{d} is the volume of a droplet. The ratio of Nₙ to Nₜ is the fraction of negative droplets.

Since the number of positive droplets, Nₚ, is equal to the difference between Nₜ and Nₙ, the concentration equivalently may be determined with Equation 2:

C=−ln(1−Nₚ/Nₜ)÷V_{d} (2)

The ratio of Nₚ to Nₜ is the fraction of positive droplets.

The concentration determined optionally may incorporate at least one adjustment, such as a proportional adjustment, introduced computationally. The adjustment may be based on calibration data obtained from a tag(s), entered by a user, and/or a measured ambient condition. The adjustment may correct for a difference between standard and measured operating conditions for emulsion formation and/or signal detection, between a nominal droplet volume for the entire cartridge and a nominal droplet volume specific to each emulsion production unit thereof, and/or between a consumable from a particular lot and a standard/reference form of the consumable. Further aspects of computational concentration adjustments are described elsewhere herein, such as in Section V.

### V. Cartridge Calibration

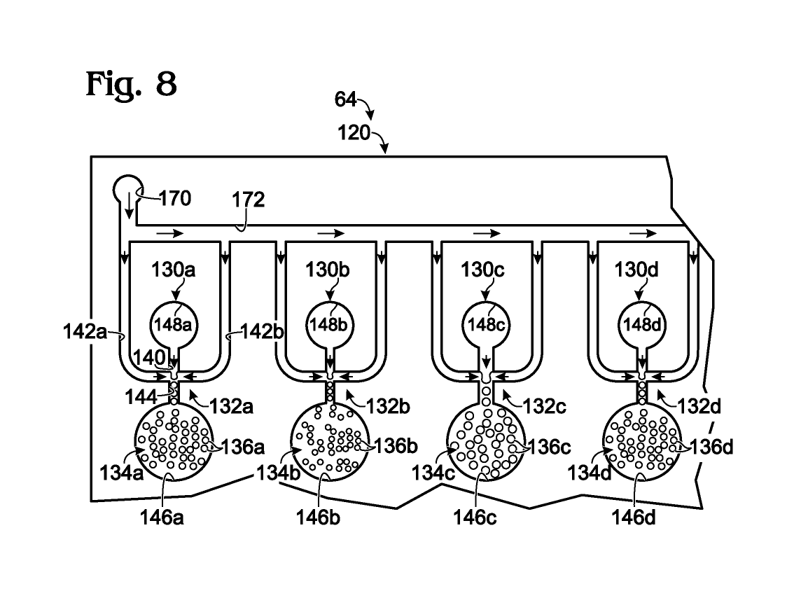

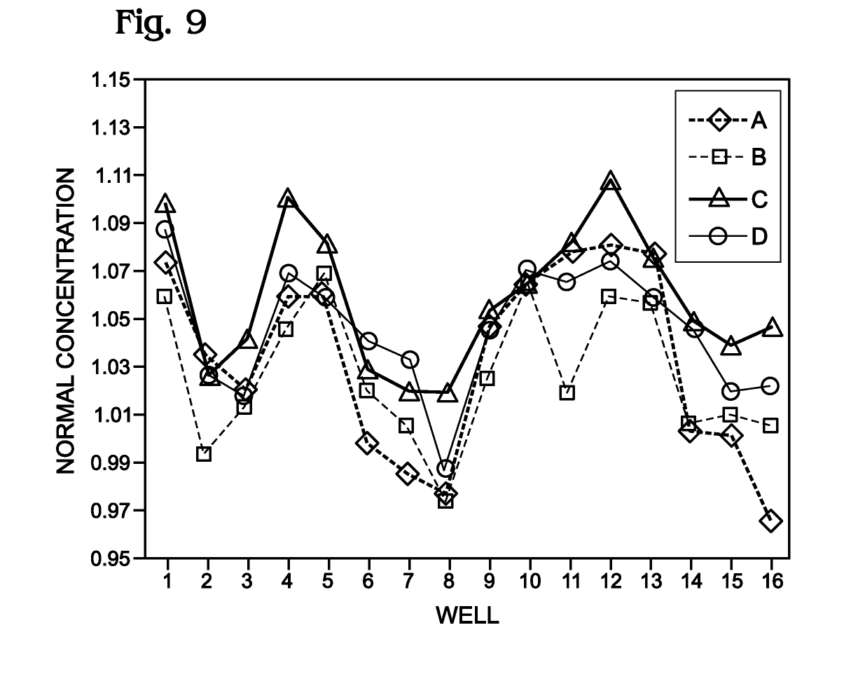

This section describes exemplary approaches to calibrating a cartridge and particularly separately calibrating the volume of droplets formed by each droplet generator of the cartridge; see FIGS. 8-10. The approaches described herein could also or alternatively be utilized to calibrate the expected droplet-generation run time for the cartridge (e.g., to verify proper operation during droplet generation) and generated volume (e.g., to control or verify proper droplet reading).

FIG. 8 shows a fragmentary, schematic plan view of cartridge 120 of FIG. 3. Four emulsion production units 130a-130d are depicted and operate as described for FIG. 5. More particularly, each unit 130a-130d includes a respective sample well 148a-148d, sample input channel 140, carrier input channels 142a and 142b, a droplet generator 132a-132d, and an emulsion well 146a-146d. Respective droplets 136a-136d of emulsions 134a-134d are being formed with sample fluid supplied from each sample well 148a-148d and carrier fluid supplied to each of units 130a-130d from a carrier port 170 via a manifold 172. In FIG. 8, droplet formation is in progress: droplets 136a-136d are being formed and emulsions 134a-134d are being collected in emulsion wells 146a-146d.

Cartridge 120 may be configured to form droplets of a single nominal size for the entire cartridge. Although units of emulsion production units 130a-130d, and particularly droplet generators 132a-132d, may be copies of one another within manufacturing tolerances, they are not perfect copies and thus droplets 136a-136d of emulsions 134a-134d differ in size relative to one another. An exemplary variation in size among the sets of droplets is grossly exaggerated in FIG. 8 to make size differences readily visible. Droplets 136a and 136d are intermediate in size, while droplets 136b are smaller and droplets 136c are larger. The size variation may be small, such as about 1% to 20% or 2% to 10%, among others, but significant enough to degrade the accuracy and precision of droplet assays.

The size variation of the droplets may be the result of the manufacturing process. The variation may be caused by dimensional differences among the molded regions (i.e., open forms of channels 140, 142a, 142b, and/or 144) of droplets generators 132a-132d. For example, in FIG. 8, sample input channels 140 of droplet generators 132b and 132c are respectively narrower and wider than of the corresponding sample input channels of droplet generators 132a and 132d. In other examples, the depth of the channels also or alternatively may vary among the droplet generators to produce droplets of different size. Decreasing the size of channel 140 only, or channel 140 and channels 142a, 142b together, may generate smaller droplets, but decreasing the size of channels 142a, 142b only can generate larger droplets by changing the carrier-to-sample ratio. Accordingly, empirically determining the size of droplets generated is generally required to compare droplet generators.

Droplet size variation also or alternatively may, for example, be the result of a film-bonding process that closes each open channel by forming a ceiling or floor of the channel. The film-bonding process can be less reproducible than the molding process, resulting in even larger variations across the chip, and also from lot to lot. Further aspects of manufacturing cartridges are described in the patent applications listed above under Cross-References, which are incorporated herein by reference, particularly U.S. Patent Application Publication No. 2014/0312534 A1, published Oct. 23, 2014.

FIG. 9 shows a graph of exemplary normalized concentration data obtained from experiments performed with four working copies, A to D, of an injection-molded cartridge 120 constructed generally as in FIG. 3. Each well in the graph is an emulsion well representing a specific one of the sixteen emulsion production units of the cartridge. The four copies of the cartridge exhibited reproducible, position-specific variation of the concentration, which is correlated among the cartridges. For example, Well 1 has a consistently higher normalized concentration for the four copies, while Well 8 is consistently lower. Accordingly, the concentration for each set of droplets can be calculated with a calibration value(s) specific to the corresponding droplet generator, to correct for variations in droplet size among the droplet generators resulting from the manufacturing process. Each calibration value can be lot-specific and position-specific within a cartridge.

The repeatability of microfluidic cartridge manufacturing (injection molding and bonding, cartridge to cartridge) may be better than the repeatability of manufacturing the injection-molding tools (channel to channel and also tool to tool) for making the cartridges. Thus, using a calibration correction factor associated with a given droplet generator produced by a given tool/mold, and/or produced in a given production lot, can improve the accuracy of the concentrations calculated. In addition, injection-molding tools can be “rescued” that would have been scrapped for not generating droplet sizes within specification.

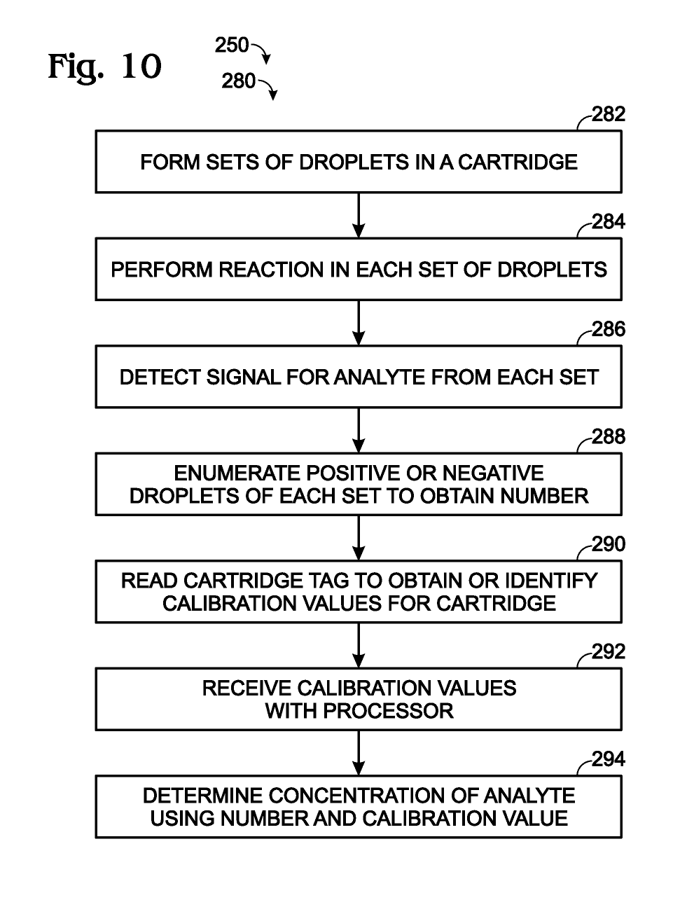

FIG. 10 shows a flowchart listing exemplary steps in a method 280 of performing a droplet assay with automatic adjustment of analyte concentration based on calibration data associated with a cartridge tag. The method steps presented in this section may be performed in any suitable order and combination, and may be modified or supplemented with any other suitable aspects of the present disclosure, such as in Sections I to IV, among others.

A plurality of sets of droplets (i.e., emulsions) may be formed in a copy of a cartridge, indicated at 282. Each set of droplets may be formed by a respective droplet generator having a defined position and thus a unique identifier within an array formed by the droplet generators of the cartridge copy. For example, an array of sixteen droplet generators may be identified by the numbers 1 to 16. The emulsion well that collects droplets from the droplet generator, and thus the set of droplets (and the emulsion) formed by the droplet generator, also may be identified and tracked with the same identifier.

A reaction may be performed in each emulsion, indicated at 284. Any suitable reaction may be performed as described above in Section IV.

A signal for an analyte may be detected from each set of droplets, indicated at 286. The analyte may be different between two or more of the emulsions, and may be present in each droplet of only a subset of the droplets of each emulsion. The signal may vary according to whether or not at least one copy of the analyte is present in each droplet, and may be processed to assign individual droplets as positive or negative for the analyte. In some embodiments, the signal may vary according to three or more different levels of an analyte in individual droplets, and may or may not be processed to assign one of the three or more levels of the analyte to each droplet.

Droplets that are positive or that are negative for the analyte may be enumerated to obtain a number for each set of droplets, indicated at 288.

A tag associated with the cartridge copy may be read, indicated at 290. The tag may encode or identify calibration data, as described elsewhere herein. The calibration data may include at least one respective calibration value corresponding to each droplet generator of the cartridge copy, and associated with the unique identifier for the droplet generator. The calibration value may relate to a droplet volume specific to the droplet generator. For example, the calibration value may correspond to a nominal droplet volume that is specific to the droplet generator (relative to other droplet generators of the cartridge copy), or a value corresponding to a relationship (e.g., a ratio) between a generator-specific nominal droplet volume and a nominal droplet volume for the entire cartridge, among others. In some embodiments, one or more or all of the calibration values may be entered by a user.

The calibration values may be received with a processor, indicated at 292. As described elsewhere herein, the values may be obtained from a tag reader, another source, and/or a user.

A concentration of an analyte may be determined and reported for each set of droplets, indicated at 294. The concentration may, for example, be calculated using the number of positive or negative droplets, a total number of droplets for the set of droplets, and a calibration value corresponding to the unique identifier for the droplet generator that formed the set of droplets, and thus corresponding to the set of droplets itself. In exemplary embodiments, the calibration value may correspond to a nominal droplet volume specific to the droplet generator, and the concentration may be calculated as shown in Equation 3 for each emulsion:

C=−ln(Nₙ/Nₜ)÷Vᵢ (3)

In Equation 3, C is concentration, Nₙ is the number of negative droplets, Nₜ is a total number of droplets, and Vᵢ is a nominal droplet volume for the i-th droplet generator of the cartridge. Accordingly, Equation 3 may be utilized with each of the nominal droplet volumes defined by the calibration data associated with the cartridge copy.

In some embodiments, the calibration data may include a separate calibration factor f for each droplet generator and a nominal droplet volume V_{c} for the entire cartridge copy. Accordingly, the analyte concentration for the i-th set of droplets may be calculated with Equation 4:

C=−ln(Nₙ/Nₜ)÷(V_{c}*fᵢ) (4)

### VI. Pressure Adjustments

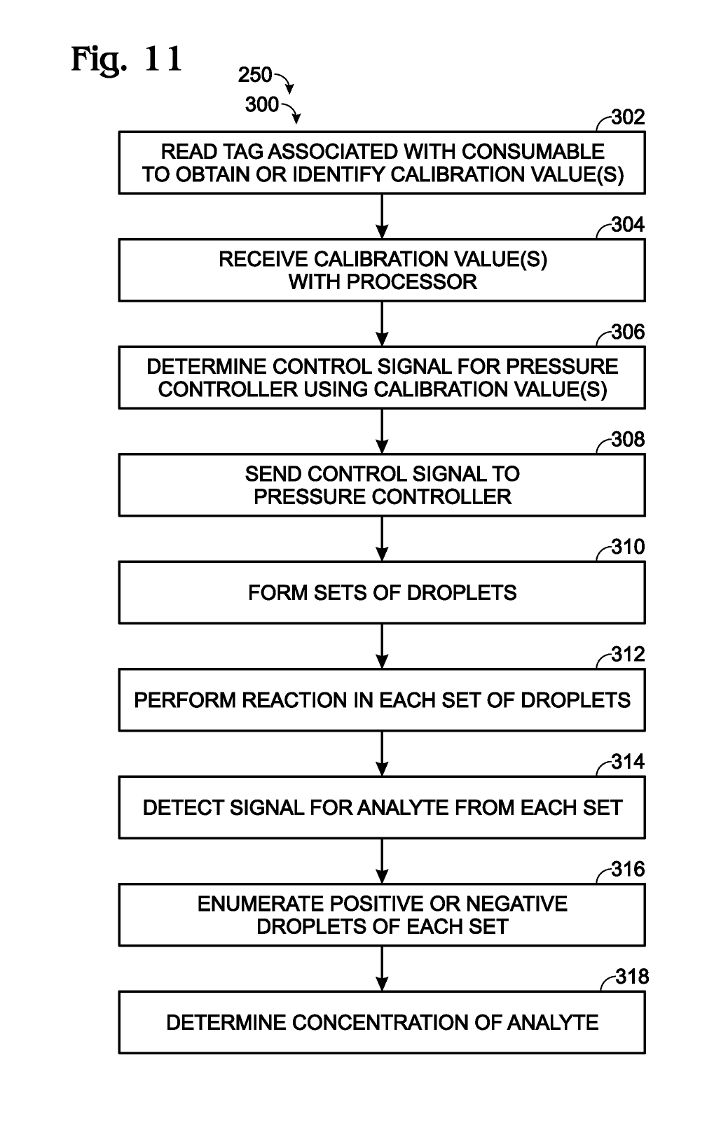

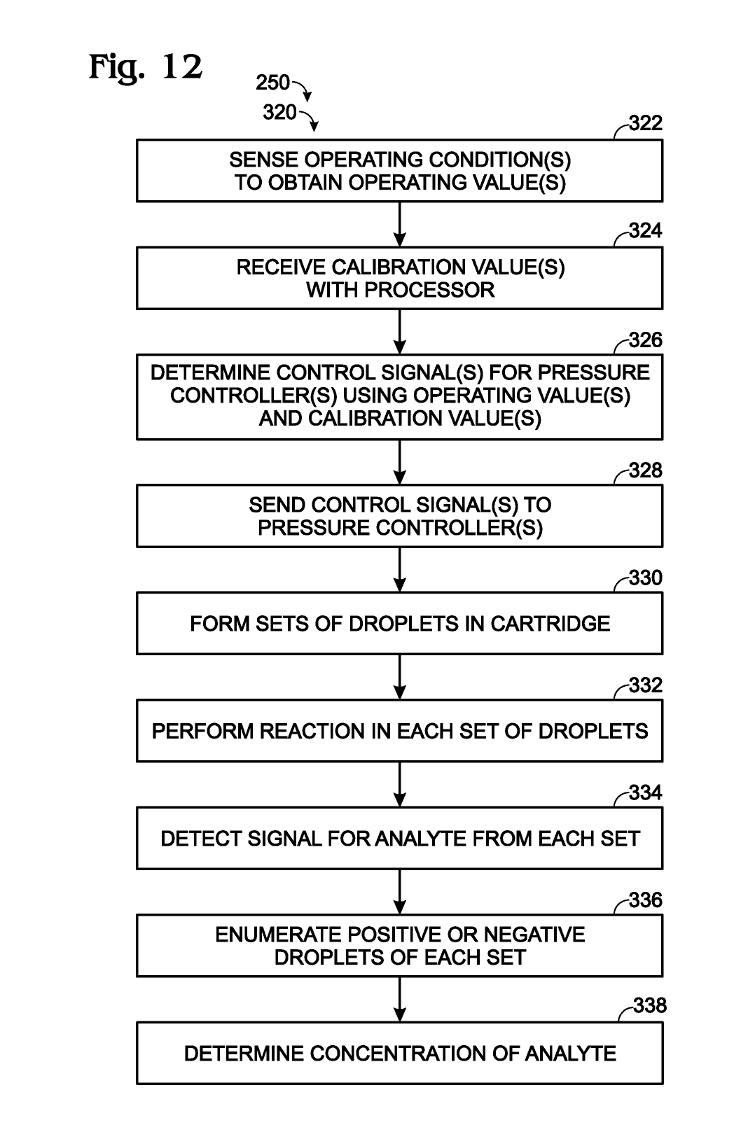

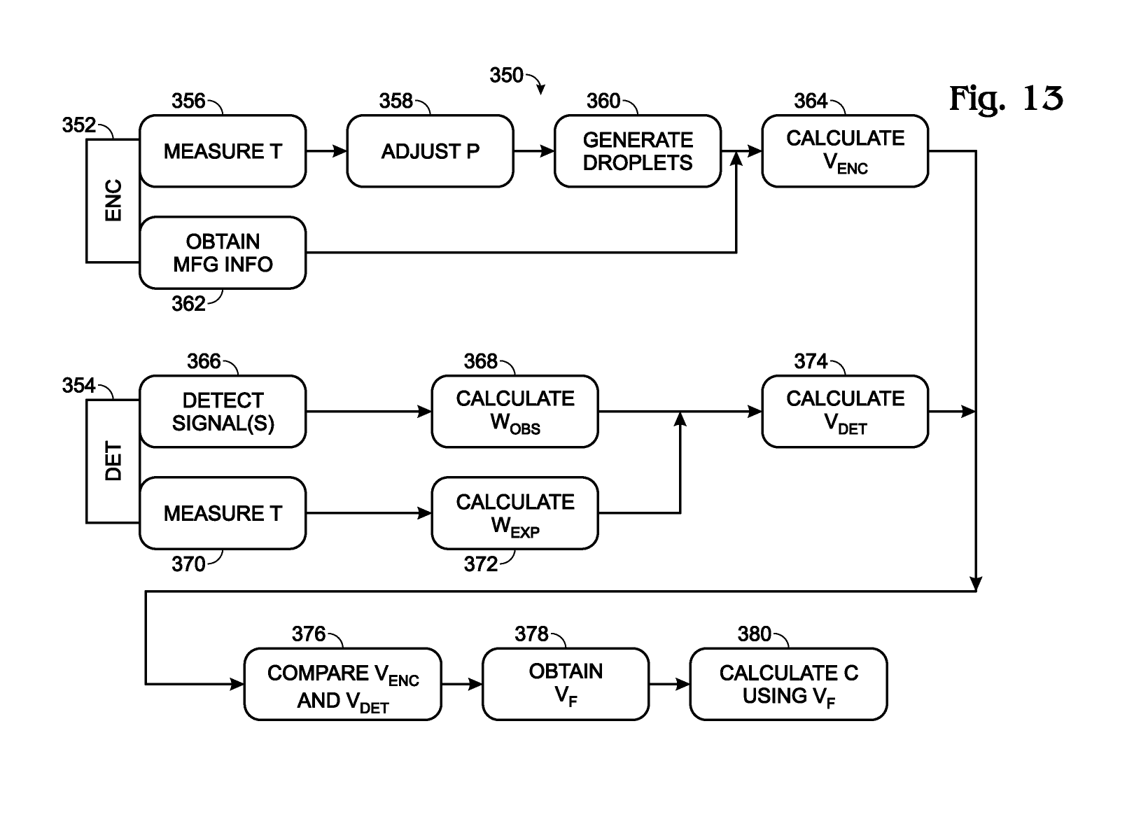

This section describes exemplary approaches to adjusting at least one negative or positive pressure applied to fluid in a droplet assay system based on calibration data associated with one or consumables, and/or an operating condition(s) (e.g., temperature, pressure, humidity, etc.) measured by the system; see FIGS. 11 and 12.

FIG. 11 shows a flowchart listing exemplary steps in a method 300 of performing a droplet assay with automatic adjustment of pressure for droplet formation and/or signal detection based on calibration data associated with a consumable. Method 300 is an example of method 250 of Section IV (see FIG. 7). The method steps presented for method 300 may be performed in any suitable order and combination, and may be modified or combined with any other suitable aspects of the present disclosure, such as in Sections I-V, among others.

Steps 302 and 304 correspond to step 252 of method 250. One or more tags may be read and calibration data including one or more calibration value(s) may be received. At least one calibration value may correspond to a viscosity of a carrier fluid (e.g., carrier fluid 66 of FIG. 1), a dilution fluid (e.g., dilution fluid 68 of FIG. 1), and/or an aqueous reagent mixture (e.g., mixture 110 of FIG. 2). At least one calibration value may be a specific calibration value corresponding to a specific emulsion production unit of a cartridge and/or to each of the emulsion production units of a cartridge (a global calibration value for the cartridge).

Step 306 corresponds to step 256 of method 250. One or more control signals may be generated to control operation of one or more pressure controllers. Each control signal may include an adjustment based on at least one of the calibration values, such as at least one calibration value corresponding to the viscosity of the carrier fluid, dilution fluid, and/or reagent mixture, optionally adjusted according to a measured operating condition (e.g., temperature and/or barometric pressure; see FIG. 12). Alternatively, or in addition, the adjustment may be based on a specific calibration value and/or a global calibration value for a droplet generation cartridge. The control signal may be generated with an algorithm that uses one or more of the calibration values as inputs. The algorithm may calculate a suitable control signal or retrieve the control signal from a look-up table, among others. The pressure controllers may drive formation of droplets and/or travel of droplets through an examination site, among others. Accordingly, in step 308, a control signal may be sent to one or both pressure controllers at an appropriate time(s).

Steps 308 and 310 correspond to step 258 of method 250. One or more sets of droplets may be formed in response to a control signal determined at step 306 and sent at step 308.

Steps 312 and 314 correspond to steps 260 and 262 of method 250. Signal detection may include driving flow of fluid through an examination site from which the signal is detected, with the flow of fluid being driven by a pressure controller. Steps 306 and 308 may be performed to adjust pressure exerted on the fluid, and thus the flow rate through the examination site, based on one or more calibration values of a consumable fluid (e.g., carrier fluid, dilution fluid, and/or a reagent mixture).

Steps 316 and 318 correspond to steps 264 and 266 of method 250. Droplets may be enumerated and a concentration of an analyte determined. The concentration may be calculated using at least one calibration value for a consumable, and optionally a lot-specific or tool-specific calibration value for the consumable.

FIG. 12 is a flowchart listing exemplary steps in a method 320 of performing a droplet assay with automatic adjustment of pressure based on a measured ambient condition. Method 320 is an example of method 250 of Section IV. The method steps presented for method 320 may be performed in any suitable order and combination, and may be modified or combined with any other suitable aspects of the present disclosure, such as in Sections I-V and method 300, among others. The method steps presented in method 320 are as described for corresponding steps of method 250 and are only described further below where elaboration is informative.

Variations in droplet volume can be induced by fluctuation of operating conditions, such as temperature and pressure (barometric). For example, viscosity (and associated flow rates) can change with temperature thus affecting the droplet formation process. These environmental dependencies can be calibrated out by building empirical or theoretical curves, then storing such dependencies in the instrument firmware or software. A correction based on a measured operating condition(s) also or alternatively can be applied when the concentration of an analyte is calculated.

One or more operating conditions may be measured to obtain or more operating values, indicated at 322. The operating values may correspond to a measured value for an operating temperature and/or a barometric pressure.

One or more calibration values may be received with a processor, indicated at 324. At least one of the calibration values may correspond to a physical property of a consumable fluid utilized in the method. The physical property may, for example, be viscosity, density, boiling point, or the like. The at least one calibration value may provide a standard value for the physical property, such as at a given temperature (e.g., 25° C.). At least one of the calibration values may correspond to a sensitivity of the physical property to changes in temperature, such as how the viscosity of a consumable fluid changes with temperature.

At least one control signal for at least one pressure controller may be determined using at least one of the operating values and at least one of the calibration values, indicated at 326. The control signal may be determined with an algorithm having at least one operating value and at least one calibration value as inputs.

### VII. Droplet Assays with Calculation of a Detection-Based Droplet Volume

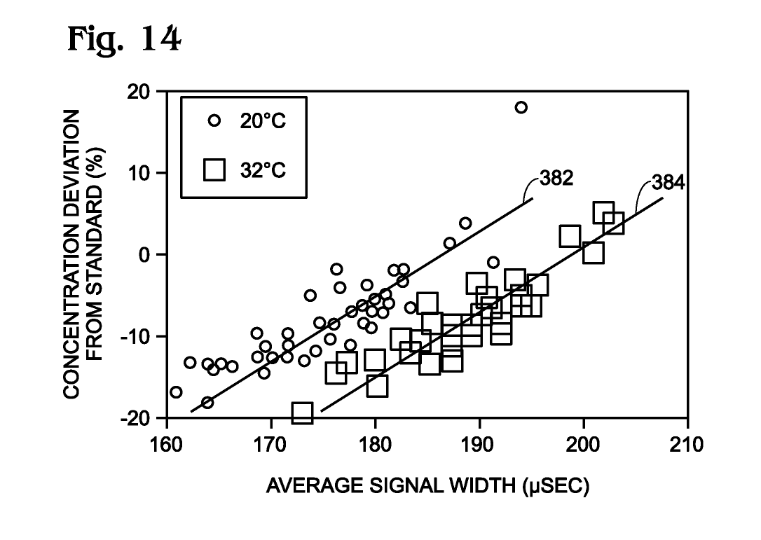

This section describes further aspects of the droplet assays disclosed herein, particularly, methods and systems that include calculation of a detection-based droplet volume, V_{DET}, using a signal detected from droplets; see FIGS. 13 and 14. The method steps disclosed in the section may be performed in any suitable order and combination, and may be combined with any suitable aspects of the methods disclosed elsewhere herein, such as those described in Sections IV-VI, and may be performed with any of the droplet assay systems disclosed herein, such as those described in Sections I-III.

FIG. 13 shows a flowchart listing exemplary steps that may be performed in a droplet-based method 350 of determining an analyte concentration. (The analyte may be described as a target.) The method has two branches, namely, an encapsulation (ENC) branch 352 and a detection (DET) branch 354, in which an encapsulation-based volume (V_{END}) and a detection-based volume (V_{DET}) for the droplets of each emulsion are calculated. The method may be performed with calculation of both volumes, or, in some embodiments, with calculation of either the encapsulation-based volume or the detection-based volume, but not both volumes.

Encapsulation branch 352 already has been described generally elsewhere herein, such as in Sections IV and V, but will be reviewed here briefly. The encapsulation branch of the method may, for example, be performed with an encapsulation system, an environmental sensor, a tag reader, and an associated processor (e.g., a computer).

An environmental temperature may be measured with a temperature sensor, indicated at 356, to obtain an operating temperature value. The operating temperature value, alone or in combination with a reference temperature value (e.g., a ratio or arithmetic difference of the values), may be used to calculate an appropriate adjustment to the pressure applied to the droplet generators. For example, one or both values may provide an input for an algorithm that outputs a value corresponding to an appropriate pressure adjustment for droplet generation. The value may correspond to a control signal that is sent to a pressure controller of the system, such as at least one source of positive/negative pressure (e.g., a source including one or more pumps and/or valves). A step of adjusting pressure, indicated at 358, may adjust the pressure to be applied by the pressure controller to one or more droplet generators (e.g., each droplet generator of a cartridge), relative to a reference pressure applied under reference operating conditions (e.g., at a predefined reference temperature, such as 24 degrees Celsius (among others)). The pressure adjustment may adjust the level of negative and/or positive pressure to be applied to the cartridge, to generate droplets at 360, to compensate for the difference between the operating temperature and the reference temperature, in order to minimize temperature-dependent changes to the volume of droplets generated by each droplet generator. For example, if the current operating temperature is above the reference temperature, the pressure may be decreased, and if below the reference temperature, the pressure may be increased, due, for example, to temperature-dependent changes in the viscosity and surface tension of the fluids composing each emulsion. One or more values obtained from a tag associated with a consumable also may be utilized in calculating a suitable pressure adjustment.

Encapsulation branch 352 also may include a step of obtaining manufacturing information, indicated at 362. The manufacturing information, also described as calibration data, may be obtained from a tag associated with the cartridge and/or other consumable involved with droplet generation. For example, the information may be encoded by the tag and read from the tag by a reader. Alternatively, the tag may identify calibration data stored at a remote network location. In any event, the calibration data may include a respective value specific to each droplet generator, and/or one or more values related to a parameter of another consumable, such as a continuous phase of each emulsion formed.

An encapsulation-based volume, V_{ENC}, of the droplets of each emulsion may be calculated, indicated at 364. The volume may be calculated using a value specific to the droplet generator that formed the emulsion (i.e., specific relative to other droplet generators of the cartridge), a value corresponding to a nominal droplet volume for the droplet generators of the cartridge collectively, or both, among others. The measured temperature also may be used in the calculation of the encapsulation-based volume, if the pressure for droplet generation was not adjusted to compensate for the effect of an operating temperature above or below the reference temperature. For example, in an exemplary embodiment, intended only for illustration, the following Equations 5 and 6 approximate the change in droplet volume as a function of the temperature of droplet generation and result from empirical observations:

$$\begin{matrix}T < 24 ° C . \text{:} {V}_{EXP} = {V}_{REF} + ( 0.3 {V}_{REF} * \frac{{T}_{REF} - T}{4 ° C .} ) & ( 5 ) \\ T > 24 ° C . \text{:} {V}_{EXP} = {V}_{REF} - ( 0.15 {V}_{REF} * \frac{T - {T}_{REF}}{8 ° C .} ) & ( 6 )\end{matrix}$$

In Equations 5 and 6, V_{EXP} is the expected (average) droplet volume at the measured temperature (T), and V_{REF} is the nominal (average) droplet volume (generated at a reference temperature, T_{REF})(in this case T_{REF}=24° C.). The expected droplet volume thus progressively increases with respect to the nominal droplet volume for each degree Celsius below the reference temperature, and progressively decreases with respect to the nominal droplet volume for each degree Celsius above the reference temperature.

Detection branch 354 of method 350 provides a detection-based volume (V_{DET}) of the droplets of each emulsion. The detection branch of the method may, for example, be performed with a detection system, an environmental sensor, and an associated processor (e.g., a computer). The detection branch may rely on a predefined relationship between the average volume of a set of droplets, the average transit time (i.e., the signal width (W)) of the droplets traveling through a detection zone, and the environmental temperature, under conditions of substantially constant flow rate through the detection zone, and/or substantially constant pressure exerted by a flow controller that drives fluid flow through the detection zone. Further aspects of this relationship, and exemplary calculations are described below.

One or more signals may be detected from droplets traveling through the detection zone, indicated at 366. The signals may include a deflection signal (also called a scattering signal) detected by a deflection detector, an analyte signal detected by an analyte detector, or both, among others. Each detector may, for example, detect light and create a signal corresponding to the detected light. Accordingly, the detector may convert photons into an electrical signal, which may be an electrical current and/or voltage. The light detected may result from interaction of incident optical radiation, generated by a light source, with droplets. The interaction may deflect the light (e.g., refract, reflect, and/or scatter the light), absorb the light, produce another detectable change in a property of the light (such as a change in polarization), induce photoluminescence (e.g., fluorescence), or the like. A deflection detector may be configured to detect deflection of incident optical radiation by droplets traveling through the detection zone. An analyte detector may be configured to detect interaction of a label present in the droplets with incident optical radiation. The label may include a photoluminophore that emits light when excited with suitable excitation light from a light source. Exemplary labels for amplification assays performed in droplets include labeled probes (e.g., photoluminophore-labeled oligonucleotides) or intercalating dyes.

Each signal may be detected with respect to time. Changes in the amplitude of the signal may be produced by droplets of an emulsion passing serially through the detection zone. Accordingly, each droplet has a signal width that may be calculated from the signal, and the signal widths collectively may allow calculation of an observed signal width (Wogs) for the emulsion, indicated at 368. The observed signal width may be an average signal width for droplets of the emulsion, and may exclude signal widths from a subset of the droplets that are outliers based on any suitable criteria.

The signal width for each droplet may correspond to a time interval required for transit of the droplet through the detection zone. The signal width may be defined by any suitable criteria representing the leading edge and the trailing edge of a droplet. For example, the leading edge and trailing edge may be defined by time points at which the signal departs from and returns to baseline, time points at which the signal reaches a predefined fraction of the signal peak for the droplet (e.g., the signal width at half maximum of the peak), time points at which the signal forms a pair of peaks corresponding to the leading and trailing edges of the droplet, or the like.

A temperature associated with the step of detecting a signal may be measured, indicated at 370. The temperature may be associated temporally and spatially with operation of the detection system. For example, the temperature may correspond to the temperature of fluid flowing through the detection zone during the step of detecting a signal. The temperature may be measured before, during, and/or after the step of detecting a signal, and may be measured inside or outside the detection system. The temperature may be measured by a temperature sensor to create a measured temperature value. The measured temperature value may be used alone or in combination with a reference temperature value (e.g., a ratio or arithmetic difference of the values), to calculate an expected signal width (W_{EXP}) at the measured temperature, indicated at 372. (The expected signal width is the width expected for droplets having the nominal droplet volume.) One or both values may provide an input for an algorithm that outputs a value corresponding to the expected signal width. For example, in an exemplary embodiment, intended only for illustration, the following Equation 7 gives the change in expected signal width, W_{EXP}, as a function of a reference signal width (W_{REF}), produced by droplets having the nominal volume and detected at the reference temperature (T_{REF}), and the difference between the measured temperature ( ), and T_{REF}:

W_{EXP}=W_{REF}+(6.5×10⁻³*W_{REF}*(T−T_{REF})) (7)

In Equation 7, which is a first order, empirical approximation, the expected signal width increases (or decreases) linearly 0.65% with respect to the reference signal width for each degree Celsius above (or below) the reference temperature.

A detection-based droplet volume, V_{DET}, may be calculated, indicated at 374. The detection-based volume may be calculated with an algorithm that uses a value corresponding to the observed droplet signal width, W_{OBS}, as an input. The algorithm also may use any combination of the expected droplet signal width, W_{EXP}, the nominal droplet volume, V_{REF}, and the measured temperature as inputs. For example, in an exemplary embodiment, intended only for illustration, the following Equation 8 gives the detection-based droplet volume, V_{DET}, as a function of the nominal droplet volume, V_{REF}, and the observed and expected droplet signal widths, W_{OBS} and W_{EXP}:

$${V}_{DET} = {V}_{REF} + ( 1.5 * {V}_{REF} * \frac{{W}_{OBS} - {W}_{EXP}}{{W}_{EXP}} ) \qquad ( 8 )$$

According to Equation 8, which is a first order, empirical approximation, the detection-based volume of a set of emulsion droplets at a given measured temperature is linearly related to the observed signal width of the droplets. By substituting the right side of Equation 7 above for W_{EXP} in FIG. 8, an algorithm can be derived that calculates the detection-based volume using values for the observed signal width and the measured temperature as inputs. (Values for the reference signal width, nominal droplet volume, and reference temperature may be constants for the algorithm with a given configuration of the detection system and cartridge.)

In some embodiments, the detection-based volume, V_{DET}, may be used directly for calculation of analyte concentration. Accordingly, a number of droplets positive or negative for an analyte may be enumerated with the analyte signal, and then used to calculate an average number of analyte molecules per droplet, such as by Poisson statistics. In exemplary embodiments, a concentration then may be determined by dividing the average number of analyte molecules per droplet by the detection-based volume. Accordingly, steps of first branch 352 of method 350, other than generating droplets 360, may be omitted.

In other embodiments, the encapsulation-based volume (V_{ENC}) and the detection-based volume (V_{DET}) may be compared, indicated at 376, to determine whether the two calculated volumes meet a predefined condition indicating they are in sufficient agreement with one another. The comparison may, for example, include calculating a ratio of, or arithmetic difference between, the volumes, to obtain a comparison value, and then comparing the comparison value with at least one threshold value. As a specific example, one of the volumes may be divided by the other to obtain a ratio, and the ratio compared with a range (e.g., 0.8 to 1.2 or 0.9 to 1.1, among others), to determine whether the volumes are sufficiently similar.

A volume, V_{F}, may be obtained, indicated at 378, based on a result of the step of comparing 376. The volume is described as a “final” volume, because the volume is used to calculate a concentration (C) of an analyte, indicated at 380. The final volume may be intermediate the encapsulation-based volume and the detection-based volume, if the step of comparing finds sufficient agreement of the two volumes. For example, the final volume may be an average or a weighted average of the two volumes, among others. If the step of comparing instead finds at least a threshold amount of disparity between the two volumes, the step of obtaining 378 may include a step of selecting one of the two volumes as the final volume. For example, either the encapsulation-based volume or the detection-based volume may always be selected for use in calculating step 380, when sufficient disparity exists between the two volumes.

The concentration, C, of an analyte may be calculated using the final volume obtained. This concentration may be calculated as described above for the calculation-based volume and elsewhere herein.

FIG. 14 shows a graph plotting the deviation of calculated analyte concentration for replicate emulsions, as a function of the average detected signal width of droplets of each emulsion. Signal detection was performed with the same physical embodiment of a detection system at two different temperatures (20 or 32 degrees Celsius). The two values for each emulsion are plotted on the graph as a circle (20° C.) or a square (32° C.). Lines 382, 384 are fitted to data collected from droplets at the two respective temperatures. Since the concentration deviation is proportional the volume deviation of the droplets. This type of analysis allows empirical construction of algorithms for converting signal width to average droplet volume at a given measured temperature, such as in Equations 7 and 8 above.

Further aspects of signal detection and signal processing, such as calculating signal widths and analyte concentrations, are described in the patent documents listed above under Cross-References, which are incorporated herein by reference, particularly U.S. patent application Ser. No. 15/394,624, filed Dec. 29, 2016.

### VIII. Selected Embodiments

This section describes selected embodiments of the present disclosure as a series of indexed paragraphs. These embodiments are included for illustration and are not intended to limit or define the entire scope of the present disclosure.

Paragraph 1. An assay system, comprising: (A) a cartridge including a plurality of droplet generators configured to form emulsions of droplets having a same nominal volume; (B) a tag associated with the cartridge and encoding calibration data or an identifier thereof, the calibration data including a respective value specific to each droplet generator; (C) an encapsulation system configured to receive the cartridge and drive formation of the emulsions by the plurality of droplet generators; (D) a detection system including a detector configured to detect a signal representing an analyte from droplets of each emulsion; (E) a reader configured to read the calibration data or the identifier from the tag; and (F) a processor configured to receive the signal and the calibration data and to calculate, for each emulsion, a concentration of an analyte using at least the signal and the respective value specific to the droplet generator that formed the emulsion.

Paragraph 2. The assay system of paragraph 1, wherein the respective value corresponds to a droplet volume specific to the droplet generator, or to a relationship between the droplet volume specific to the droplet generator and the nominal volume.

Paragraph 3. The assay system of paragraph 2, wherein each respective value corresponds to a ratio of the droplet volume specific to the droplet generator and the nominal volume.

Paragraph 4. The assay system of any of paragraphs 1 to 3, wherein the calibration data includes a value representing the nominal volume of droplets for the plurality of droplet generators collectively.

Paragraph 5. The assay system of any of paragraphs 1 to 4, further comprising a temperature sensor configured to generate a temperature signal representing a temperature measured, wherein the processor is in communication with the temperature sensor and is configured to adjust a at least one positive/negative pressure applied to fluid in the cartridge by the encapsulation system based on the temperature signal.

Paragraph 6. The assay system of paragraph 5, where the processor is configured to compare the temperature signal to a reference signal to create a difference signal, to create a control signal based on the difference signal, and to communicate the control signal to the encapsulation system, and wherein the control signal increases a level of positive/negative pressure exerted on fluid in the cartridge by a source of positive/negative pressure if the temperature measured is below a reference temperature.

Paragraph 7. The assay system of any of paragraphs 1 to 6, further comprising a temperature sensor in communication with the processor and configured to measure a temperature, and wherein the processor is configured to adjust at least one positive/negative pressure applied to fluid in the cartridge with at least one source of positive/negative pressure based on a deviation of the measured temperature from a reference temperature.

Paragraph 8. The assay system of paragraph 7, wherein the processor is configured to adjust the positive/negative pressure to minimize a change in size of the droplets generated that would result from droplet generation at the measured temperature without adjusting the positive/negative pressure relative to that used by the encapsulation system at the reference temperature.

Paragraph 9. The assay system of any of paragraphs 1 to 8, wherein the processor is configured to receive a respective signal detected by a detector of the detection system from droplets of each emulsion, calculate from the respective signal an average signal width for droplets of the emulsion, calculate a detection-based volume for droplets of the emulsion based on the signal width, and compare the detection-based volume with a generation-based volume for droplets of the emulsion; wherein the concentration is calculated for the emulsion using both volumes if comparison of the detection-based volume with a generation-based volume meets a predefined condition.

Paragraph 10. The assay system of any of paragraphs 1 to 9, wherein the processor is configured to enumerate for each emulsion a number of droplets that are positive or that are negative for an analyte, and to calculate the concentration of the analyte using at least the number and the respective value for the emulsion.

Paragraph 11. The assay system of paragraph 10, wherein the processor is configured to calculate each concentration using the number of droplets that are positive or the number of droplets that are negative, a total number of droplets, and a calculated droplet volume specific to the emulsion.

Paragraph 12. The assay system of any of paragraphs 1 to 11, wherein the cartridge is a single-use cartridge.

Paragraph 13. The assay system of any of paragraphs 1 to 12, wherein each droplet generator includes a channel intersection at which droplets are generated.

Paragraph 14. The assay system of paragraph 13, wherein at least a portion of the channel intersection of each droplet generator is injection-molded.

Paragraph 15. The assay system of any of paragraphs 1 to 14, wherein the plurality of droplet generators are copies of one another.

Paragraph 16. The assay system of any of paragraphs 1 to 15, wherein the tag is configured to be read optically or by radio-frequency identification (RFID).

Paragraph 17. The assay system of paragraph 16, wherein the tag includes a barcode.

Paragraph 18. The assay system of any of paragraphs 1 to 17, wherein the tag is attached to the cartridge.

Paragraph 19. The assay system of any of paragraphs 1 to 18, wherein the cartridge is a unit belonging to a production lot of units, and wherein the same calibration data is associated with each unit.

Paragraph 20. The assay system of any of paragraphs 1 to 19, wherein the processor is configured to control the encapsulation system and the detection system.

Paragraph 21. The assay system of any of paragraphs 1 to 20, the tag being a first tag, further comprising a fluid disposed in a vessel and associated with a second tag configured to be read by the reader, wherein the tag encodes or identifies at least one calibration value for the fluid.

Paragraph 22. The assay system of paragraph 21, wherein the processor is configured to use the at least one calibration value for the fluid in generating a control signal for a source of positive/negative pressure of the encapsulation system or the detection system.

Paragraph 23. The assay system of paragraph 21 or paragraph 22, wherein the encapsulation system is configured to use the fluid as a continuous phase enclosing each droplet.

Paragraph 24. The assay system of any of paragraphs 21 to 23, wherein the detection system is configured to use the fluid as a dilution fluid for each emulsion to increase a distance between droplets passing through a detection zone of the detection system.

Paragraph 25. The assay system of any of paragraphs 21 to 24, wherein the fluid is configured to constitute at least a portion of each droplet.

Paragraph 26. The assay system of any of paragraphs 21 to 25, wherein the encapsulation system or the detection system is configured to operatively receive the vessel.

Paragraph 27. The assay system of any of paragraphs 21 to 26, wherein the at least one calibration value for the fluid corresponds to a viscosity of the fluid.

Paragraph 28. The assay system of any of paragraphs 21 to 27, wherein the processor is configured to use the at least one calibration value for the fluid in calculating a concentration of the analyte.

Paragraph 29. The assay system of any of paragraphs 21 to 28, wherein the fluid and the vessel are included in a unit belonging to a production lot of units, and wherein the same at least one calibration value for the fluid is associated with each unit.

Paragraph 30. The assay system of paragraph 29, wherein the at least one calibration value for the fluid is specific for the production lot.

Paragraph 31. The assay system of any of paragraphs 1 to 30, wherein the detection system includes a photodetector configured to detect light emitted from a photoluminophore contained by droplets of each emulsion, and wherein the photodetector is configured to create the signal based on the light detected.

Paragraph 32. A method of performing an assay with droplets, the method comprising: (A) forming emulsions with a plurality of droplet generators provided by a cartridge, wherein droplets of the emulsions have a same nominal volume; (B) detecting a signal representing an analyte from droplets of each emulsion; (C) reading a tag associated with the cartridge to obtain calibration data including a respective value specific to each droplet generator, or to obtain an identifier for the calibration data; (D) receiving the calibration data with a processor; and (E) calculating for each emulsion a concentration of the analyte with the processor using at least the signal and the respective value specific to the droplet generator that formed the emulsion.

Paragraph 33. The method of paragraph 32, wherein the step of calculating includes a step of enumerating for each emulsion a number of droplets that are positive or that are negative for the analyte based on the signal, and a step of calculating the concentration of the analyte using at least the number and the respective value specific to the droplet generator that formed the emulsion.

Paragraph 34. The method of paragraph 32 or paragraph 33, wherein the step of reading a tag includes a step of optically reading the tag or reading the tag by radio-frequency identification.

Paragraph 35. The method of any of paragraphs 32 to 34, wherein the tag is attached to the cartridge.

Paragraph 36. The method of any of paragraphs 32 to 35, the tag being a first tag, further comprising a step of reading a second tag associated with a fluid disposed in a vessel to obtain or identify at least one value for the fluid.

Paragraph 37. The method of paragraph 36, wherein the step of calculating uses the at least one value for the fluid.

Paragraph 38. The method of paragraph 36 or paragraph 37, further comprising a step of generating a control signal to control a source of positive/negative pressure for the step of forming emulsions, wherein the step of generating a control signal uses the at least one value for the fluid to determine the control signal.

Paragraph 39. The method of any of paragraphs 32 to 38, wherein droplets of each emulsion includes a label, and wherein the step of detecting a signal includes a step of detecting a signal from the label.

Paragraph 40. The method of any of paragraphs 32 to 39, wherein the step of reading a tag is performed with a reader and includes a step of obtaining calibration data encoded by the tag, further comprising a step of communicating the calibration data from the reader to the processor.

Paragraph 41. The method of paragraph 40, further comprising a step of decoding the calibration data at the reader or the processor before or after the step of communicating the calibration data.

Paragraph 42. The method of any of paragraphs 32 to 41, wherein the step of reading a tag obtains an identifier for the calibration data, and wherein the step of receiving the calibration data includes a step of receiving the calibration data with the processor from a remote network location using the identifier.

Paragraph 43. The method of any of paragraphs 32 to 42, further comprising a step of measuring a temperature and/or an atmospheric pressure to obtain at least one environmental signal, and a step of generating a control signal to control positive/negative pressure for the step of forming an emulsion and/or the step of detecting a signal, wherein the step of generating a control signal uses the at least one environmental signal.

Paragraph 44. The method of any of paragraphs 32 to 43, further comprising a step of measuring a temperature and/or an atmospheric pressure to obtain one or more measured values, wherein the step of calculating uses the one or more measured values.

Paragraph 45. A method of manufacturing a cartridge for droplet generation, the method comprising: (A) producing copies of a cartridge, each copy including a plurality of droplet generators configured to form droplets of a same nominal volume; and (B) testing one or more of the copies to obtain a respective value specific to each droplet generator, the respective value being related to a droplet volume for the droplet generator; wherein a plurality of the copies include a tag, and wherein the tag encodes the value specific to each droplet generator or an identifier thereof.

Paragraph 46. The method of paragraph 45, wherein the value corresponds to the droplet volume specific to the droplet generator or to a relationship between the droplet volume specific to the droplet generator and the nominal volume.

Paragraph 47. The method of paragraph 45 or paragraph 46, further comprising a step of assigning the copies of a cartridge to a same production lot.

Paragraph 48. The method of any of paragraphs 45 to 47, wherein the tag encodes an identifier for the production lot.

Paragraph 49. The method of any of paragraphs 45 to 48, wherein the tag encodes the value for each droplet generator.

Paragraph 50. The method of any of paragraphs 45 to 49, further comprising a step of associating the tag with each copy of the plurality of copies, and wherein the step of associating includes a step of attaching a pre-formed tag to the copy, a step of forming the tag on the copy, or a step of creating the tag as the copy is produced.

Paragraph 51. The method of paragraph 50, wherein the tag is a radio-frequency identification tag, further comprising a step of writing calibration data to the tag, the calibration data including the value for each droplet generator.

Paragraph 52. The method of any of paragraphs 45 to 51, wherein the step of producing copies of a cartridge includes a step of injection-molding a portion of the cartridge that forms at least part of each droplet generator.

Paragraph 53. The method of paragraph 52, wherein the step of producing copies of a cartridge includes a step of attaching a cover to the injection-molded portion of the cartridge, and wherein the cover forms a wall region of at least one channel of each droplet generator.

Paragraph 54. The method of any of paragraphs 45 to 53, wherein the step of testing includes a step of generating droplets with droplet generators of the one or more copies.

Paragraph 55. The method of paragraph 54, wherein the step of testing includes a step of detecting a signal from an optically detectable label present in the droplets.

Paragraph 56. The method of paragraph 54 or paragraph 55, wherein the step of testing includes a step of calculating a concentration of an analyte present in droplets formed by each droplet generator.

Paragraph 57. A droplet assay system, comprising: (A) a cartridge including a plurality of droplet generators; (B) a carrier fluid; (C) an aqueous mixture; (D) a tag associated with the cartridge, the carrier fluid, or the aqueous mixture; (E) a reader configured to obtain calibration data or an identifier thereof from the tag; (F) an encapsulation system configured to receive the cartridge, the carrier fluid, and the aqueous mixture, and to apply positive/negative pressure that drives formation of an emulsion by each droplet generator; (G) a detection system configured to detect a signal from droplets of each emulsion; and (H) a processor configured to receive the calibration data and generate a control signal for at least one positive/negative pressure source of the encapsulation system based on at least one calibration value of the calibration data.

Paragraph 58. The droplet assay system of paragraph 57, wherein the positive/negative pressure includes a vacuum applied to the cartridge, and wherein the control signal controls a level, duration, and/or profile of the vacuum.

Paragraph 59. The droplet assay system of paragraph 57 or paragraph 58, wherein the processor is configured to cause the encapsulation system to apply a different positive/negative pressure to individual droplet generators of the cartridge based on the calibration data.

Paragraph 60. The droplet assay system of any of paragraphs 57 to 59, wherein the tag is attached to or included in a packaging material for the cartridge, carrier fluid, or aqueous mixture.

Paragraph 61. A droplet assay system, comprising: (A) a cartridge including a plurality of droplet generators; (B) an encapsulation system configured to receive the cartridge and drive formation of an emulsion by each droplet generator; (C) a detection system including a detector configured to detect a signal from droplets of each emulsion; (D) a sensor configured to measure a temperature or an atmospheric pressure; and (E) a processor configured to control operation of the encapsulation system and/or the detection system with an adjustment based on the measured temperature or atmospheric pressure.

Paragraph 62. The droplet assay system of paragraph 61, wherein the encapsulation system includes a source of positive/negative pressure that drives emulsion formation, and wherein the processor is configured to generate a control signal for operation of the source using a signal measured by the sensor.

Paragraph 63. The droplet assay system of paragraph 61 or paragraph 62, wherein the detection system includes a source of positive/negative pressure that drives fluid flow to and/or from a detection zone, and wherein the processor is configured to generate a control signal for operation of the source using a signal detected by the sensor.

Paragraph 64. A method of determining a volume for droplets, the method comprising: (A) detecting a signal from droplets with a detector as the droplets pass through a detection zone; (B) calculating an average signal width for droplets from the signal; and (C) calculating a volume of the droplets based on the average signal width; wherein each step of calculating is performed with a processor.

Paragraph 65. The method of paragraph 64, wherein the step of detecting a signal includes a step of irradiating the detection zone with light and a step of selectively detecting a portion of the light deflected by droplets passing through the detection zone.

Paragraph 66. The method of paragraph 64 or paragraph 65, further comprising a step of measuring a temperature, wherein the step of calculating a volume is also based on the temperature measured.

Paragraph 67. The method of any of paragraphs 64 to 66, further comprising a step of calculating a concentration of an analyte in the droplets based on the volume calculated.

Paragraph 68. A method of performing an assay, the method comprising: (A) detecting one or more signals from droplets with at least one detector as the droplets pass through a detection zone; (B) calculating a value corresponding to a volume of the droplets based on at least one of the signals; and (C) calculating a concentration of an analyte in the droplets based at least in part on one of the one or more signals and the value corresponding to a volume of the droplets; wherein each of the steps of calculating is performed with a processor.

Paragraph 69. The method of paragraph 68, the value being a first value corresponding to a detection-based volume of the droplets, the method further comprising generating the droplets with a droplet generator; obtaining a second value corresponding to a generation-based volume of the droplets; wherein the step of calculating a concentration is performed with a third value obtained from the first and second values and corresponding to a final volume that is intermediate the detection-based volume and the generation-based volume.

Paragraph 70. The method of paragraph 69, wherein the third value corresponds to an unweighted or weighted average of the detection-based volume and the generation-based volume.

Paragraph 71. The method of paragraph 69 or paragraph 70, wherein the step of obtaining a second value includes a step of obtaining a generation-based volume of the droplets using a nominal value for droplet volume provided by a manufacturer of the droplet generator.

Paragraph 72. The method of paragraph 71, wherein the nominal value is used as the generation-based volume.

Paragraph 73. The method of paragraph 71 or paragraph 72, wherein the droplet generator is provided by a cartridge having a plurality of droplet generators, wherein the nominal value is for the plurality of droplet generators collectively, further comprising a step of obtaining a value specific to the droplet generator, wherein the second value corresponding to the generation-based volume of the droplets is calculated using the nominal value and the value specific to the droplet generator.

Paragraph 74. The method of any of paragraphs 71 to 73, further comprising a step of measuring a temperature at which the step of generating droplets is performed, wherein the nominal value is for a reference temperature, and wherein the step of obtaining a second value includes a step of adjusting the nominal value based on the measured temperature to account for a change in droplet size resulting from a difference between the measured temperature and the reference temperature.

Paragraph 75. The method of any of paragraphs 71 to 74, wherein the droplet generator is provided by cartridge having a plurality of droplet generators, wherein the nominal volume is for the plurality of droplet generators collectively, further comprising a step of reading a value specific to the droplet generator from a tag associated with the cartridge, wherein the respective value corresponds to a droplet volume specific to the droplet generator, or to a relationship between the droplet volume specific to the droplet generator and the nominal volume.

Paragraph 76. A method of performing an assay, the method comprising: (A) generating droplets at a channel intersection of a droplet generator; (B) detecting one or more signals from the droplets with at least one detector as the droplets pass through a detection zone; (C) obtaining, with a processor, a first value corresponding to a generation-based volume of the droplets; (D) calculating a second value corresponding to a detection-based volume of the droplets with the processor using at least one signal of the one or more signals; (E) calculating a final volume for the droplets using at least the first value and the second value; and (F) calculating a concentration of an analyte in the droplets based on a signal of the one or more signals and the final volume.

The term “about,” as used herein with respect to a value, means within 10% of the stated value. For example, a dimension described as being “about 10” means that the dimension is greater than 9 and less than 11.

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure. Further, ordinal indicators, such as first, second, or third, for identified elements are used to distinguish between the elements, and do not indicate a particular position or order of such elements, unless otherwise specifically stated.

We claim:

1. An assay system, comprising:
a cartridge including a plurality of droplet generators configured to form emulsions of droplets having a same nominal volume;
a tag associated with the cartridge and encoding calibration data or an identifier thereof, the calibration data including a respective value specific to each droplet generator;
an encapsulation system configured to receive the cartridge and drive formation of the emulsions by the plurality of droplet generators;
a detection system including a detector configured to detect a signal representing an analyte from droplets of each emulsion;
a reader configured to read the calibration data or the identifier from the tag; and
a processor configured to receive the signal and the calibration data and to calculate, for each emulsion, a concentration of an analyte using at least the signal and the respective value specific to the droplet generator that formed the emulsion.

2. The assay system of claim 1, wherein the respective value corresponds to a droplet volume specific to the droplet generator, or to a relationship between the droplet volume specific to the droplet generator and the nominal volume.

3. The assay system of claim 2, wherein each respective value corresponds to a ratio of the droplet volume specific to the droplet generator and the nominal volume.

4. The assay system of claim 1, wherein the calibration data includes a value representing the nominal volume of droplets for the plurality of droplet generators collectively.

5. The assay system of claim 1, further comprising a temperature sensor configured to generate a temperature signal representing a temperature measured, wherein the processor is in communication with the temperature sensor and is configured to adjust a at least one positive/negative pressure applied to fluid in the cartridge by the encapsulation system based on the temperature signal.

6. The assay system of claim 5, where the processor is configured to compare the temperature signal to a reference signal to create a difference signal, to create a control signal based on the difference signal, and to communicate the control signal to the encapsulation system, and wherein the control signal increases a level of positive/negative pressure exerted on fluid in the cartridge by a source of positive/negative pressure if the temperature measured is below a reference temperature.

7. The assay system of claim 1, further comprising a temperature sensor in communication with the processor and configured to measure a temperature, and wherein the processor is configured to adjust at least one positive/negative pressure applied to fluid in the cartridge with at least one source of positive/negative pressure based on a deviation of the measured temperature from a reference temperature.

8. The assay system of claim 7, wherein the processor is configured to adjust the positive/negative pressure to minimize a change in size of the droplets generated that would result from droplet generation at the measured temperature without adjusting the positive/negative pressure relative to that used by the encapsulation system at the reference temperature.

9. The assay system of claim 1, wherein the processor is configured to
receive a respective signal detected by a detector of the detection system from droplets of each emulsion,
calculate from the respective signal an average signal width for droplets of the emulsion,
calculate a detection-based volume for droplets of the emulsion based on the signal width, and
compare the detection-based volume with a generation-based volume for droplets of the emulsion;
wherein the concentration is calculated for the emulsion using both volumes if comparison of the detection-based volume with a generation-based volume meets a predefined condition.

10. The assay system of claim 1, wherein the processor is configured to enumerate for each emulsion a number of droplets that are positive or that are negative for an analyte, and to calculate the concentration of the analyte using at least the number and the respective value for the emulsion.

11. The assay system of claim 10, wherein the processor is configured to calculate each concentration using the number of droplets that are positive or the number of droplets that are negative, a total number of droplets, and a calculated droplet volume specific to the emulsion.

12. The assay system of claim 1, wherein the tag is configured to be read optically or by radio-frequency identification (RFID).

13. The assay system of claim 1, wherein the cartridge is a unit belonging to a production lot of units, and wherein the same calibration data is associated with each unit.

14. A method of performing an assay with droplets, the method comprising:
forming emulsions with a plurality of droplet generators provided by a cartridge, wherein droplets of the emulsions have a same nominal volume;
detecting a signal representing an analyte from droplets of each emulsion;
reading a tag associated with the cartridge to obtain calibration data including a respective value specific to each droplet generator, or to obtain an identifier for the calibration data;
receiving the calibration data with a processor; and
calculating for each emulsion a concentration of the analyte with the processor using at least the signal and the respective value specific to the droplet generator that formed the emulsion.

15. The method of claim 14, wherein the step of reading a tag includes a step of optically reading the tag or reading the tag by radio-frequency identification.

16. A method of manufacturing a cartridge for droplet generation, the method comprising:
producing copies of a cartridge, each copy including a plurality of droplet generators configured to form droplets of a same nominal volume; and
testing one or more of the copies to obtain a respective value specific to each droplet generator, the respective value being related to a droplet volume for the droplet generator;
wherein a plurality of the copies include a tag, and wherein the tag encodes the value specific to each droplet generator or an identifier thereof.

17. The method of claim 16, wherein the value corresponds to the droplet volume specific to the droplet generator or to a relationship between the droplet volume specific to the droplet generator and the nominal volume.

18. The method of claim 16, wherein the tag is a radio-frequency identification tag, further comprising a step of writing calibration data to the tag, the calibration data including the value for each droplet generator.

19. The method of claim 16, wherein the step of testing includes a step of generating droplets with droplet generators of the one or more copies.

20. The method of claim 16, wherein the step of testing includes a step of detecting a signal from an optically detectable label present in the droplets.

21. The method of claim 16, wherein the step of testing includes a step of calculating a concentration of an analyte present in droplets formed by each droplet generator.
